(19) United States
(12) Patent Application Publication
(10) Pub. No.: US 2010/0049482 A1
(43) Pub. Date: Feb. 25, 2010

(54) SYSTEM AND METHOD FOR ICTAL SOURCE ANALYSIS

(75) Inventors: Bin He, Arden Hills, MN (US); Lei Ding, Norman, OK (US); Yuan Lai, Kirkland, WA (US)

Correspondence Address: SCHWEGMAN, LUNDBERG & WOESSNER, P.A., P.O. BOX 2938, MINNEAPOLIS, MN, 55402, US

(73) Assignee: Regents of the University Of Minnesota, st paul, MN (US)

(21) Appl. No.: 12/255,324

(22) Filed: Oct. 21, 2008

Related U.S. Application Data
(63) Continuation of application No. PCT/US2007/009638, filed on Apr. 20, 2007.
(60) Provisional application No. 60/793,989, filed on Apr. 21, 2006.

(51) Int. Cl. G06F 17/11

(52) U.S. Cl. 703/2

(57) ABSTRACT

This document discloses, among other things, ictal source analysis and causal interaction estimation which considers the structure of seizures in the space, time, and frequency domains. The dynamic causal interaction can distinguish the primary source, which initiates the ictal activity, from the secondary source, which is generated due to the ictal activity propagation.

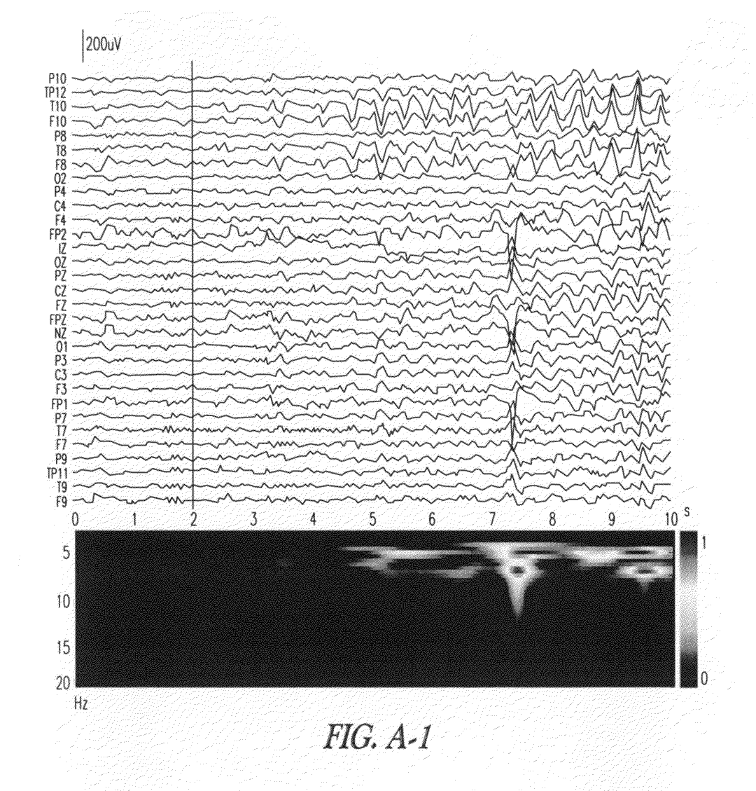

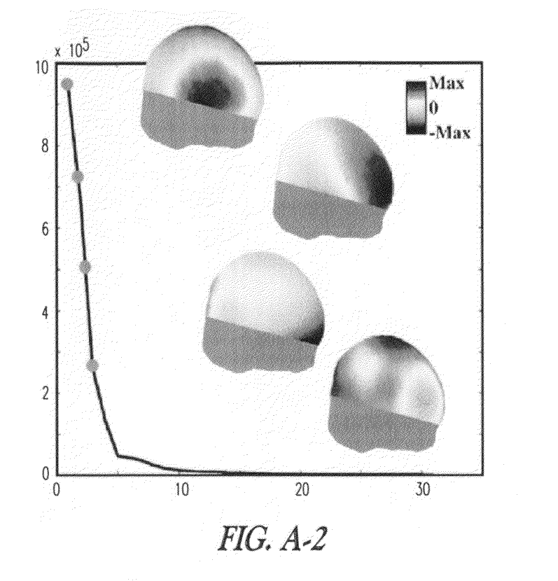

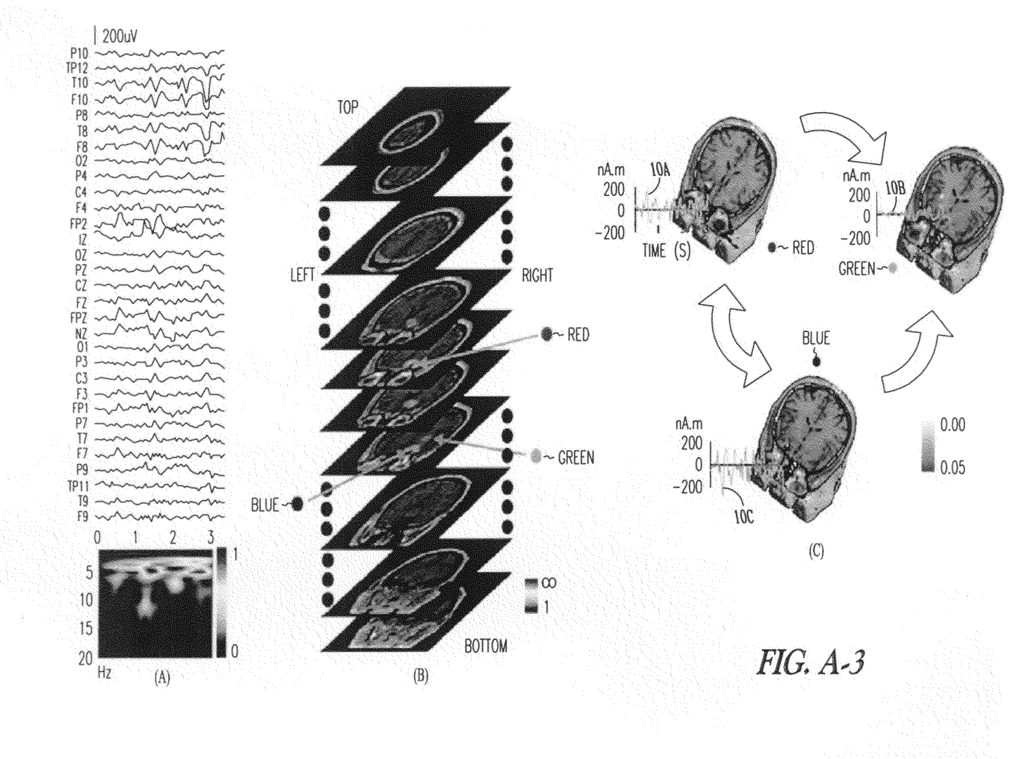

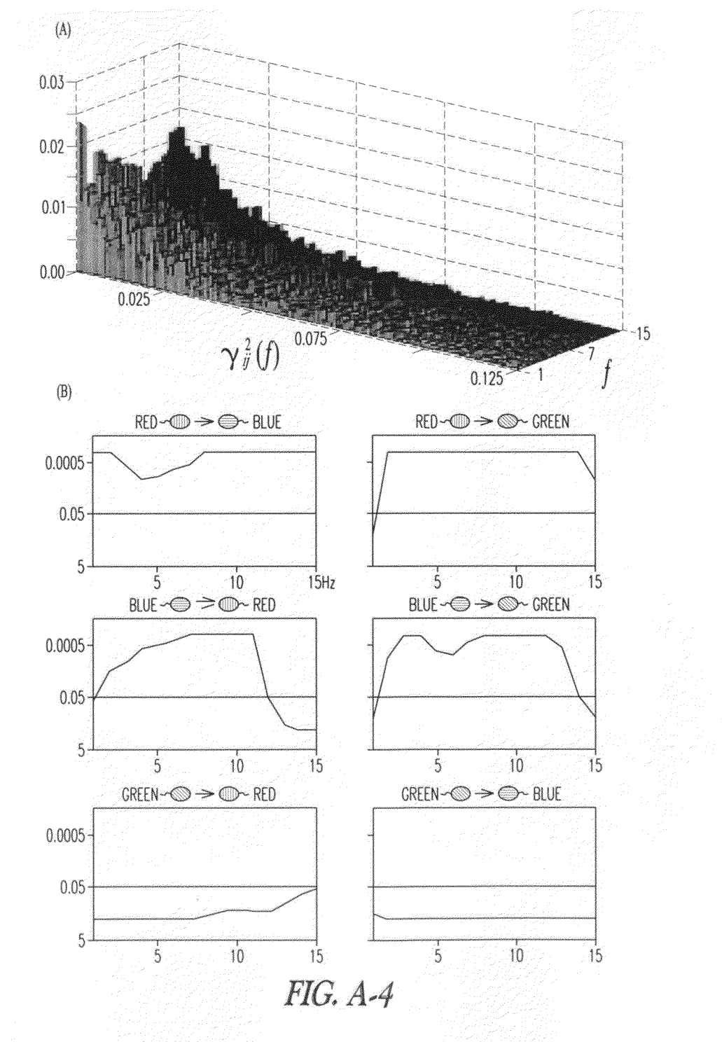

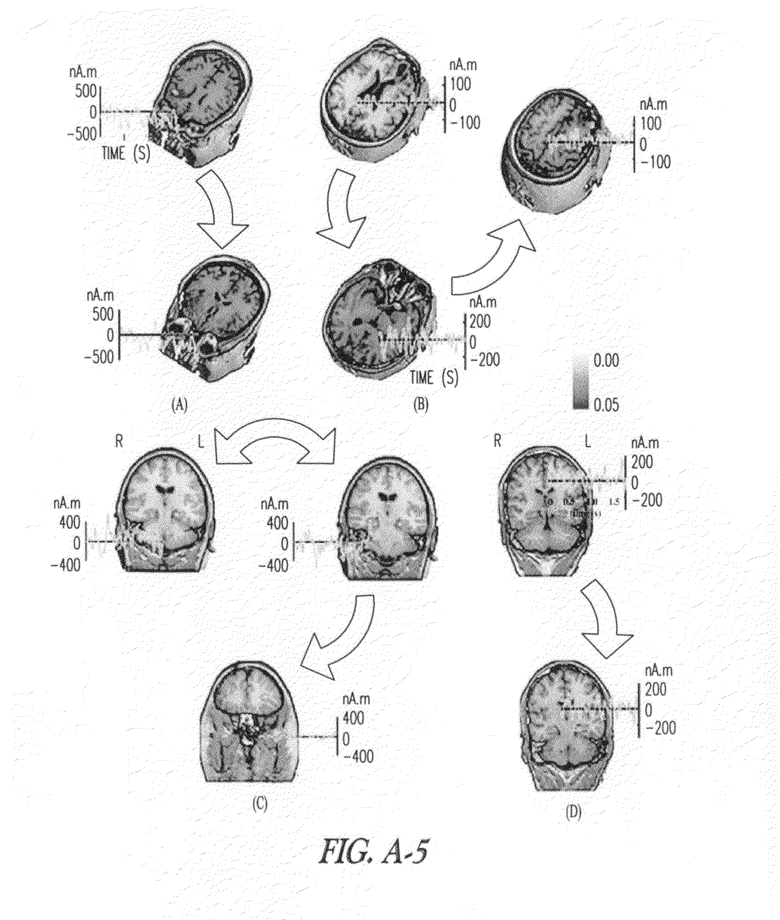

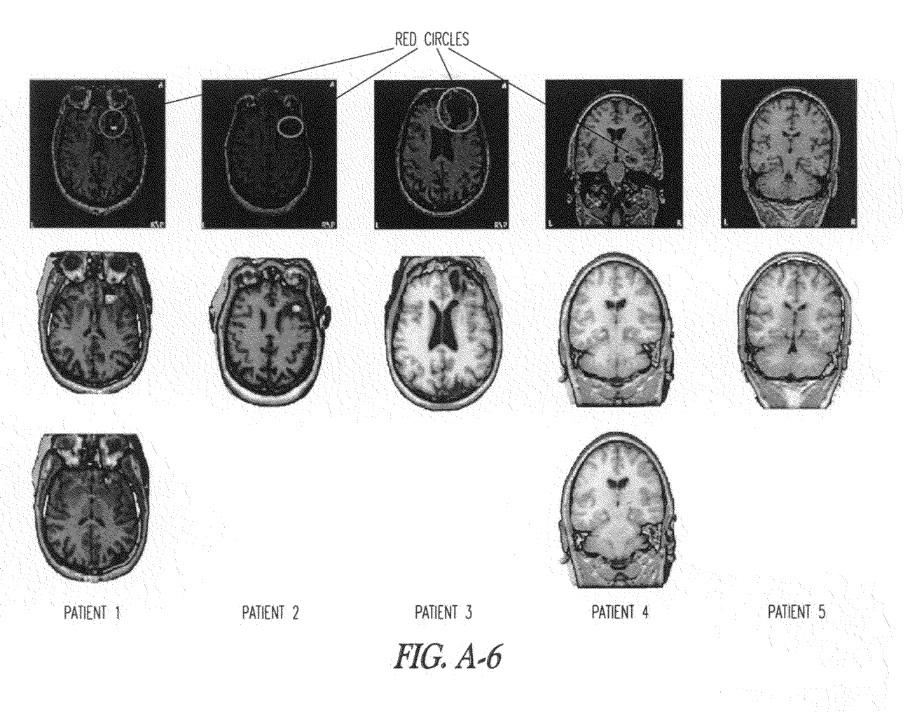

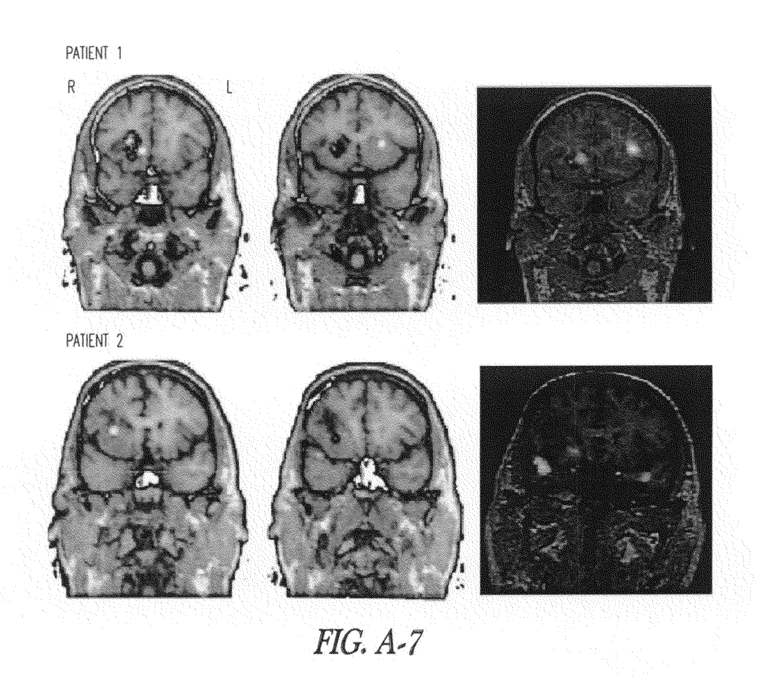

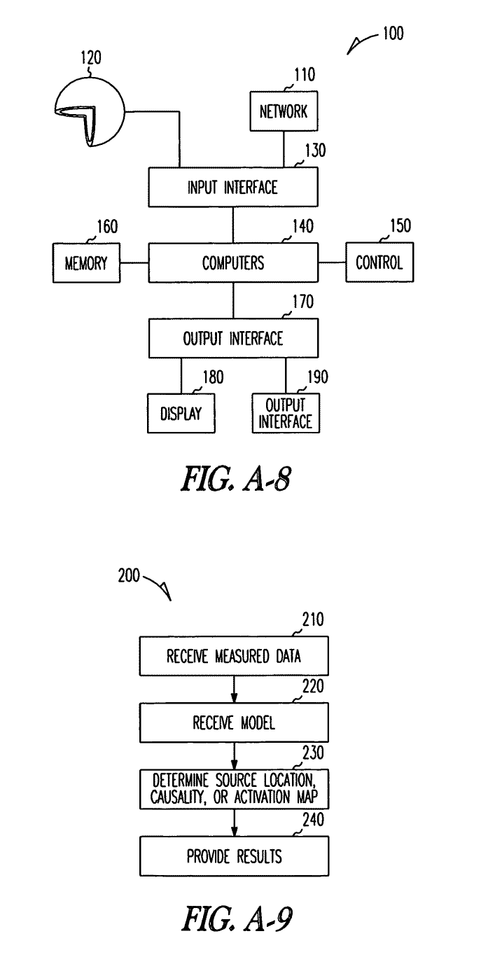

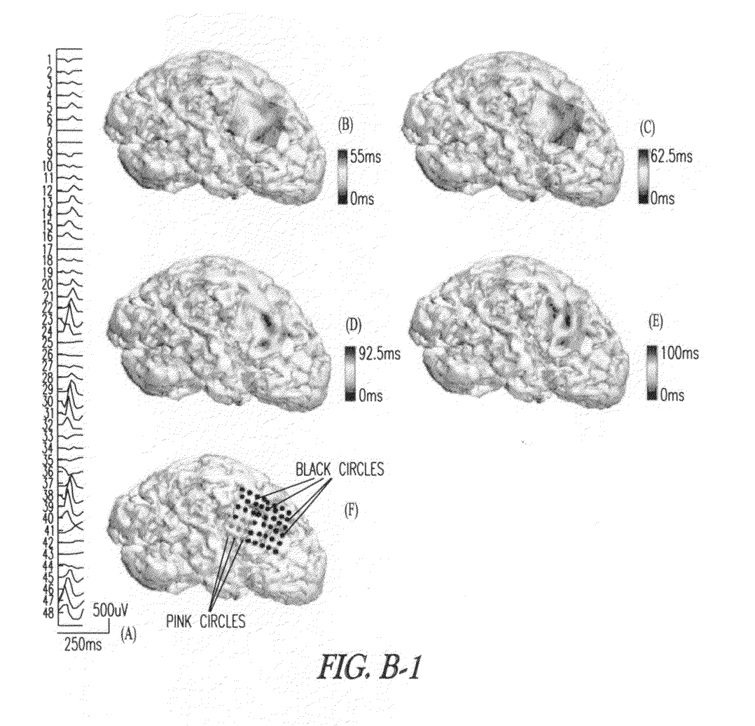

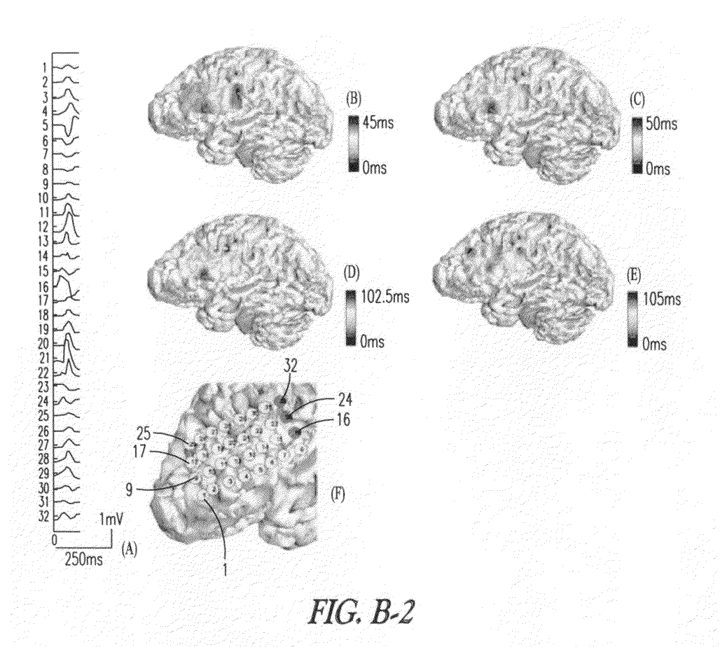

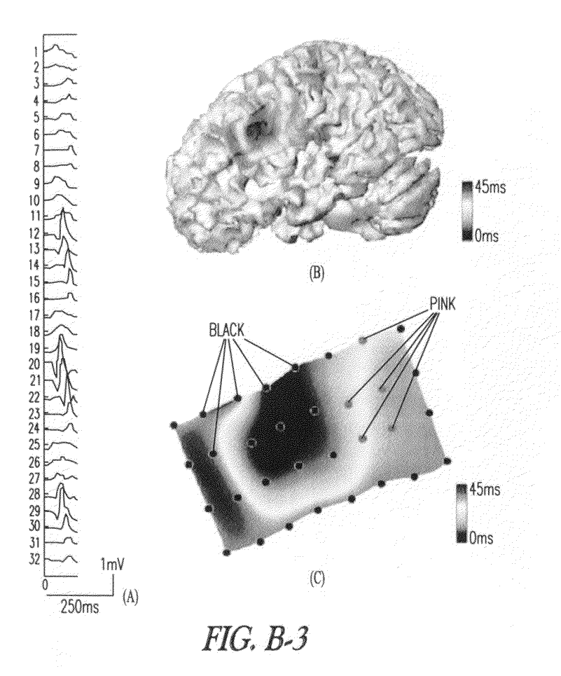

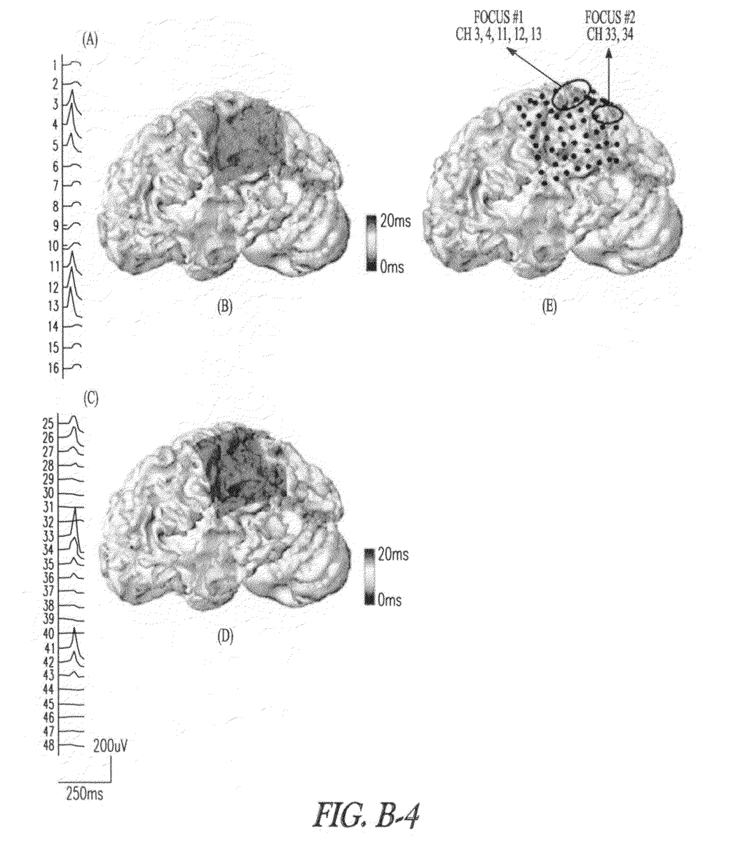

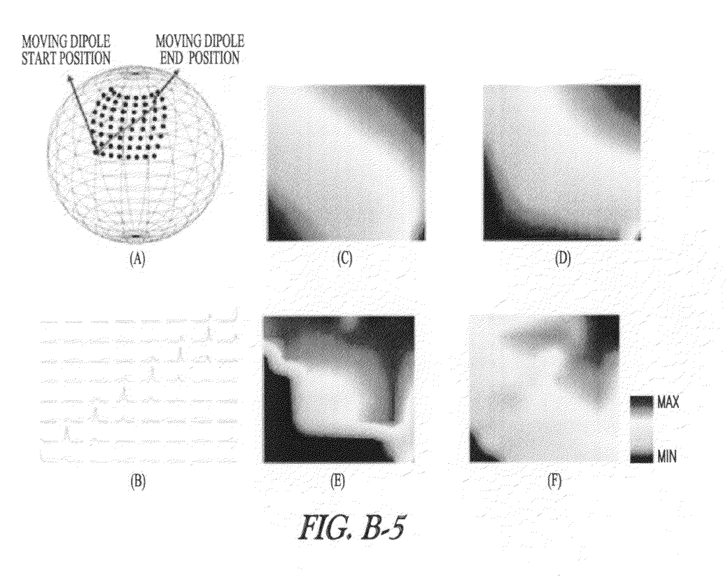

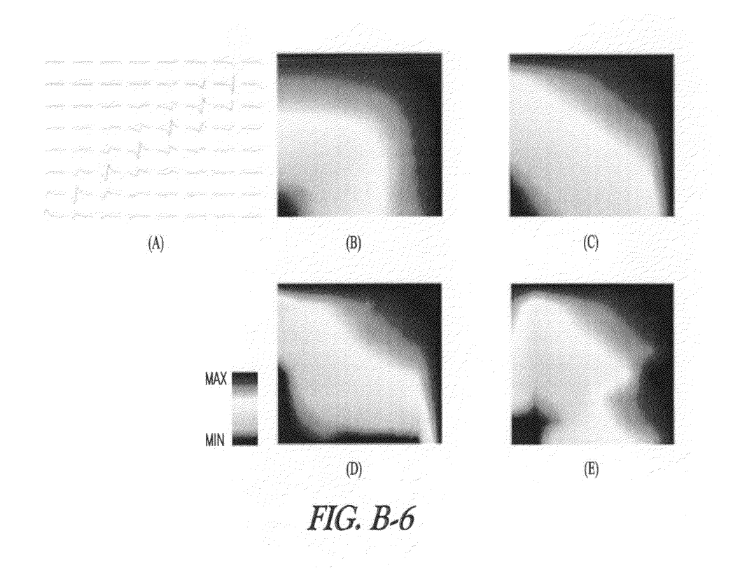

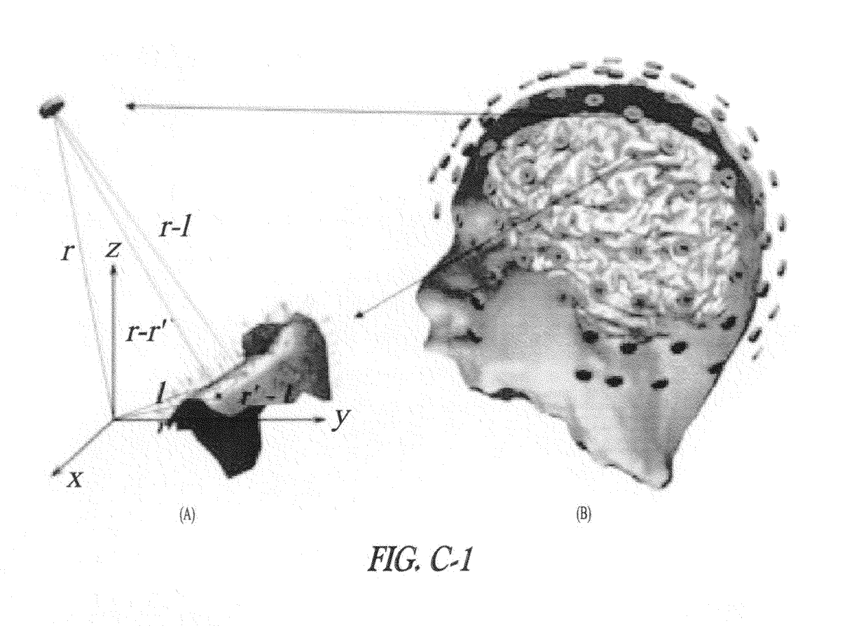

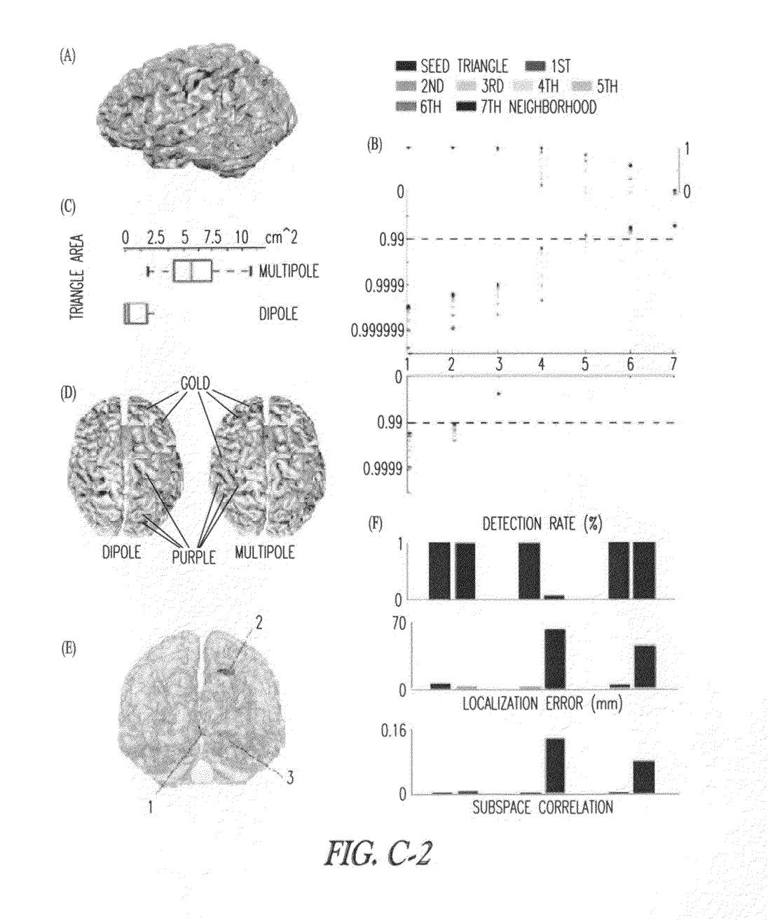

### CROSS-REFERENCE TO RELATED PATENT DOCUMENTS

### Priority of Invention

This application is a Continuation Under 35 U.S.C. §1.111 (a) of International Application No. PCT/US2007/009638, filed Apr. 20, 2007 and published in English as WO 2007/124040 on Nov. 1, 2007, which claims the benefit of priority under 35 U.S.C. Section 119(e), to Bin He et al., U.S. Provisional Patent Application Ser. No. 60/793,989, entitled “METHOD AND APPARATUS OF ACTIVATION AND CAUSALITY IMAGING OF BIOELECTRICAL ACTIVITY,” filed on Apr. 21, 2006; which applications and publication are hereby incorporated by reference and made a part hereof.

### GOVERNMENT RIGHTS

This invention was made with Government support under Grant Numbers R01-EB00178 awarded by the National Institutes of Health, and under Grant Number BES-0411898, awarded by the National Science Foundation. The Government has certain rights in this invention.

### TECHNICAL FIELD

This document pertains generally to source analysis, and more particularly, but not by way of limitation, to mapping the activation and causal interaction of bioelectrical activity.

### BACKGROUND

In clinical research and practice, understanding the internal generators responsible for seizures can help in determining the epileptogenic zone in patients being considered for surgical resection. Traditional analysis methods involving inspection of EEG traces are poorly suited to disentangle measured pathological activity.

### OVERVIEW

The present subject matter includes methods and systems for ictal source analysis that integrates various information in the space, time, and frequency domains. One example includes performing a spatio-temporal multiple source localization task to locate multiple sources that are responsible for broad-frequency and time-evolving ictal rhythms. The temporal dynamics of the multiple sources can be characterized using multi-variate auto-regressive (MVAR) modeling to determine an estimated causal interaction topography among the sources. The source analysis and causal interaction can be presented graphically and displayed in an image.

Example 1 includes a system comprising an interface configured to receive data from a brain, a memory to store a model for the brain, and a processor coupled to the interface and the memory and having instructions stored thereon for executing an algorithm to solve an inverse problem using the data and the model, the solution including an estimate of temporal distribution for a plurality of sources and generating parameters corresponding to connectivity for a plurality of sources based on the solution.

Example 2 includes the system of example 1 optionally including wherein the interface is coupled to a plurality of surface sensors.

Example 3 includes the system of one or any combination of examples 1 and 2 and optionally includes wherein the processor is configured to execute a subspace source localization algorithm.

Example 4 includes the system of one or any combination of examples 1 to 3 and optionally wherein the computer is configured to implement a directed transfer function (DTF) algorithm.

Example 5 includes the system of one or any combination of example 1 to 4 and optionally wherein the computer is configured to analyze connectivity for a plurality of regions of the brain at a particular frequency.

Example 6 includes the system of one or any combination of example 1 to example 5 and optionally wherein the computer is configured to execute a structured equation method.

Example 7 includes the system of one or any combination of example 1 to example 6 and optionally wherein the computer is configured to identify a primary source.

Example 8 includes a computer implemented method comprising receiving a set of measurements from a brain, receiving a model for the brain, solving an inverse problem using the set of measurements and the model, the solution including an estimate of temporal distribution for a plurality of sources, analyzing connectivity of the plurality of sources based on the solution, and generating a parameter to describe connectivity as to at least two sources.

Example 9 includes the system of example 8 optionally including wherein receiving the set of measurements includes receiving at least one of electroencephalograph data and magnetoencephalograph data.

Example 10 includes the system of one or any combination of example 8 and example 9 and optionally wherein receiving the model includes receiving at least one of a dipole distribution and a multipole distribution.

Example 11 includes the system of one or any combination of example 8 to example 10 and optionally wherein solving the inverse problem includes executing a subspace source localization algorithm.

Example 12 includes the system of one or any combination of example 8 to example 11 and optionally wherein analyzing connectivity includes executing a directed transfer function (DTF).

Example 13 includes the system of one or any combination of example 8 to example 12 and optionally wherein analyzing connectivity includes analyzing a plurality of regions of the brain at a particular frequency.

Example 14 includes the system of one or any combination of example 8 to example 13 and optionally wherein analyzing connectivity includes executing a structured equation method.

Example 15 includes the system of one or any combination of example 8 to example 14 and optionally wherein generating the parameter includes identifying a primary source.

Example 16 includes a system comprising an interface configured to receive electrical signals from a set of sensors, the electrical signals corresponding to activity of a brain, a computer configured to execute an algorithm to derive an activation pattern based on the electrical signals, and a memory coupled to the computer and configured to store the activation pattern.

Example 17 includes a system of example 16 and optionally wherein the interface is configured to receive a signal from a surface sensor.

Example 18 includes the system of one or any combination of example 16 to example 17 and optionally wherein the interface is configured to receive a signal from an intracranial sensor.

Example 19 includes the system of one or any combination of example 16 to example 18 and optionally wherein the computer is configured to execute an algorithm to solve an inverse problem.

Example 20 includes a computer implemented system comprising receiving electrical signals from a set of sensors, the electrical signals corresponding to activity of a brain, executing an algorithm to derive an activation pattern based on the electrical signals, and storing data corresponding to the activation pattern in a memory of the computer.

Example 21 includes the system of example 20 and optionally wherein receiving electric signals includes receiving signals from a surface sensor.

Example 22 includes the system of one or any combination of example 20 and example 21 and optionally wherein receiving electric signals includes receiving signals from an intracranial sensor.

Example 23 includes the system of one or any combination of example 20 and example 22 and optionally wherein executing the algorithm includes solving an inverse problem.

Example 24 includes a computer implemented method comprising receiving information corresponding to signals originating in a brain, the information derived from external sensors distributed about the brain, identifying a source location within a three dimensional space occupied by the brain, and storing the source location in a memory.

Example 25 includes the system of example 24 and optionally wherein identifying the source location includes identifying a primary source.

Example 26 includes the system of one or any combination of example 24 to example 25 and optionally wherein identifying the source location includes identifying a secondary source.

Example 27 includes the system of one or any combination of example 24 to example 26 and optionally wherein identifying includes comparing with a threshold.

Example 28 includes the system of one or any combination of example 24 to example 27 and optionally further including determining multiple source locations within the three dimensional space.

Example 29 includes the system of one or any combination of example 24 to example 28 and optionally further including determining a direction of propagation between two source locations selected from the multiple source locations.

Example 30 includes the system of one or any combination of example 24 to example 29 and optionally wherein receiving information includes receiving information corresponding to at least one of a magnetic field sensor and an electric field sensor.

Example 31 includes a computer implemented method comprising receiving electrophysiological data from a brain, executing a spatio-temporal source localization algorithm on the computer using the data to locate multiple sources, modeling behavior of the sources using a multivariate autoregressive process, estimating causal interaction among the sources based on a frequency and the modeled behavior, and storing a result corresponding to the estimated causal interaction, the result stored in a memory accessible to the computer.

Example 32 includes the system of example 31 and optionally wherein executing the spatio-temporal source localization algorithm includes performing a three-dimensional source scanning procedure.

Example 33 includes the system of one or any combination of example 31 to example 32 and optionally wherein executing the spatio-temporal source localization algorithm includes performing singular value decomposition (SVD).

Example 34 includes the system of one or any combination of example 31 to example 33 and optionally wherein executing the spatio-temporal source localization algorithm includes executing a subspace source localization algorithm.

Example 35 includes the system of one or any combination of example 31 to example 34 and optionally wherein estimating the causal interaction includes estimating a plurality of causal patterns.

Example 36 includes the system of one or any combination of example 31 to example 35 wherein estimating causal interaction includes determining at least one of a primary source and a secondary source.

Example 37 includes the system of one or any combination of example 31 to example 36 and optionally wherein estimating causal interaction includes executing a directed transfer function (DTF) procedure.

Example 38 includes the system of one or any combination of example 31 to example 37 and optionally wherein estimating causal interaction includes generating a surrogate data set.

Example 39 includes the system of one or any combination of example 31 to example 38 and optionally wherein estimating the causal interaction includes identifying an epileptogenic zone.

Example 40 includes the system of one or any combination of example 31 to example 39 and optionally wherein estimating causal interaction includes solving an inverse problem.

Example 41 includes the system of one or any combination of example 31 to example 40 and optionally wherein receiving electrophysiological data includes receiving at least one of intracranial data, electroencephalogram (EEG) data, and magnetoencephalogram (MEG) data.

Example 42 includes the system of one or any combination of example 31 to example 41 and optionally wherein executing the spatio-temporal source localization algorithm includes using at least one of a dipole source model, a multipole source model, and a distributed source model.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. A-1 illustrates a multi-channel scalp waveform and time-varying energy of the ictal rhythm in each frequency band in a time-frequency representation.

FIG. A-2 illustrates an example of a curve for singular values from the SVD analysis of an ictal rhythm for the patient data depicted in FIG. A-1 as well as four scalp potential patterns (up-down sequence) for the corresponding singular vectors for the four largest singular values.

FIG. A-3A illustrates a scalp waveform.

FIG. A-3B illustrates a 3D scanning result by FINE for sample ictal activity.

FIG. A-3C illustrates locations, waveforms, and causality patterns for identified sources from FIG. A-3B.

FIG. A-4A illustrates a histogram of the surrogate DTF function values as a function of frequency.

FIG. A-4B illustrates statistical significances of the DTF function values as a function of frequency.

FIGS. A-5A to A-5D illustrates locations, waveforms, and causality patterns from ictal source analysis of selected patients.

FIG. A-6 illustrates MRI images of primary source locations and lesions for selected patients.

FIG. A-7 illustrates examples of SPECT scans and ictal source localization analysis.

FIG. A-8 illustrates a block diagram of a system according to one example.

FIG. A-9 illustrates a flow chart of a method according to one example.

FIG. B-1 illustrates cortical activation mapping (CAM) analysis for a patient.

FIG. B-2 illustrates CAM analysis for a patient.

FIG. B-3 illustrates an example in which CAM analysis does not correspond to IOZ determined from ictal ECoG recordings.

FIG. B-4 illustrates CAM analysis for patients with multiple epileptogenic foci.

FIG. B-5 illustrates computer simulation of CAM analysis using a single moving radial dipole.

FIG. B-6 illustrates computer simulation of CAM analysis using single tangential dipole moving from lower left corner to upper right corner with eccentricity of 0.80.

FIG. C-1 illustrates a model having an enlarged cortical source.

FIG. C-2 illustrates a simulation.

### DETAILED DESCRIPTION

### Preliminaries

The following detailed description includes references to the accompanying drawings, which form a part of the detailed description. The drawings show, by way of illustration, specific embodiments in which the invention can be practiced. These embodiments are also referred to herein as “examples.” The embodiments can be combined, other embodiments may be utilized, or structural, logical and electrical changes can be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Part A

### Introduction

One example of an ictal source analysis method includes three components. First, a three-dimensional source scanning procedure is performed by a spatio-temporal subspace source localization method to locate the multiple sources responsible for the time evolving ictal rhythms at their onsets. Next, the dynamic behavior of the sources is modeled by a multivariate autoregressive process (MVAR). Lastly, the causal interaction patterns among the sources as a function of frequency are estimated from the MVAR modeling of the source temporal dynamics. Outcomes from this analysis can include, for example, source locations, source temporal dynamics, and causality patterns. The causal interaction patterns indicate the dynamic communications between sources, which can distinguish the primary sources responsible for the ictal onset from the secondary sources caused by the ictal propagation. The present subject matter can be applied to epilepsy patients.

### Context

Medical facilities, including epilepsy treatment centers, have used various non-invasive continuous EEG and video monitoring of patients as well as MEG-based technologies.

An epileptologists can manually screen out suspect seizures, which may be buried in continuous multiple time series EEG traces from multiple channels, using morphology, amplitude, and frequency information. The seizure localization is then said to relate to the channels exhibiting the most significant activities. The spectral analysis of rhythmic discharges in seizures can lead to the explicit formulation of seizure spatial patterns at specific frequency components and, thus, allow for quantitative evaluations.

These analysis techniques, in both time and frequency domains, aids the noninvasive lateralization and localization of seizures. However, the relatively large distance between the electrodes and the cortex, along with the smearing caused by the volume conductor effect of a series of barriers (scalp, skull, and dura mater) means that manual methods are unable to accurately characterize information regarding source locations.

Seizure localization has been advanced by source localization and imaging techniques using both EEG and MEG. Both EEG and MEG can be used to characterize the structures of seizures in the source space domain instead of the field measurement domain. Such techniques handle the volume conductor effect and, thus, are able to identify the internal sources behind the seizures by solving the so-called inverse problem.

In such methods, the sources of ictal rhythms are modeled as a spatio-temporal dipole. Thus, seizure generators are characterized by a few discrete dipoles with temporal evolvements. Other methods have combined the frequency analysis and dipole source localization together to provide an “FFT dipole approximation”.

In order to model multiple and more distributed seizure sources, the distributed source model has also been used rather than the dipole source model because the modeling accuracy of the discrete dipole sources decreases when both the number of sources and extent of sources increase. However, the source imaging using the distributed source model is usually performed on single snapshot data which is not sufficient in handling a temporally evolving activity like a seizure. It is neither straightforward nor proper to perform source imaging on arbitrary single snapshots from an ictal rhythm.

Other methods have included the temporal segmentation of ictal rhythms which divide activities in the time domain into a series of “functional microstates” with each microstate stable within its time window. The source localization could thus be achieved using a mean potential map from a microstate. Others have extended the “FFT dipole approximation” method from the dipole source model to the distributed source model in which a source imaging technique, known as LORETA, is applied to seizure analysis on a frequency component.

These methods integrate information from the space, time, and frequency domains which enables seizure source characterization. The idea behind these approaches includes a two-steps procedure: (i) multi-channel time-frequency parameterization of EEG or MEG time series; (ii) source localization or imaging on the parameterized EEG or MEG components. The first step narrows down the information from the scalp recordings into certain spatial patterns within a time domain or specific frequency bin. The hypothesis behind them assumes that the parameterization only rejects signals which are not of interest.

This, however, is not always true. While the parameterized components often lose useful signals, it is also difficult to delineate the signals of interest without proper manipulation and justification. In terms of seizure source localization, one difficulty is distinguishing the sources which initiate the seizure activity (the primary sources) from the sources which are generated by propagation of pathological activity (the secondary sources).

Propagation of seizure activity can be very rapid in time and within similar bands in frequency. Additionally, areas of propagation in space can be distant from the primary focus such as in cortical areas contralateral to pathological structures. Another complication for ictal source analysis is determining the time point of seizure onset. However, the determination of seizure onset by an experienced epileptologist may not be accurate enough to delineate the influence from pathological propagation, which often complicates the seizure onset activity and leads to false localization or even false lateralization of ictal events.

### Source Analysis and Causality

The present subject matter includes an ictal source analysis method including (i) spatio-temporal source localization or imaging followed by (ii) time-frequency parameterization of time series from multiple sources. This analysis method avoids compression of the signals in time domain and avoids narrowing the signals into specific frequency bins. The source localization, or imaging, can be used with either a dipole source model or a distributed source model.

In one example, a subspace source localization method is based upon the dipole source model which allows for multiple source localization. The dynamics of these sources can be reconstructed and the causal interaction patterns among these sources in the spectral domain can be estimated by a directed transfer function (DTF) technique. Such causal interaction patterns can parameterize the seizure source structure in both time and frequency domains and to distinguish the primary sources from secondary sources in the space domain.

The DTF causality estimate technique, as applied to EEG or MEG signals, is based on the Granger (1969) theory. While Granger causality can be applied to determine the directional causal interaction between two signals at a time, the DTF technique can be used to determine the directional causal interaction for an arbitrary number of signals. The DTF technique estimates the causal interaction through multivariate autoregressive (MVAR) modeling of multi-channel EEG or MEG signals.

The DTF technique can be applied to determine the onset and propagation of seizure activities using intracranial recordings. Intracranial recordings allow measuring ECoG at field points close to the sources whereas EEG and MEG scalp recordings are measured at relatively far fields. Therefore, the causal relationship between neighboring channels in EEG and MEG scalp recordings can be complicated by the volume conductor effect.

However, ECoG is invasive and, due to the difficulties in obtaining broad cortical coverage, electrodes may not practically be placed over the entire area of interest, which may include, for example, the epileptogenic zone.

A causal interaction estimate on the source space, determined by solving the inverse problem, can avoid invasive measurements and can provide information about a greater portion of the cortex.

The present subject matter includes an integrative technique to characterize the structure of seizures in the space, time, and frequency domains.

The present subject matter allows distinguishing the primary sources from secondary sources.

The method is based upon a combination of the subspace source localization technique and the spectrum-based causal interaction estimation technique employing the directed transfer function (DTF). The subspace source localization procedure, performed as the first step in ictal analysis method, analyzes measured spatio-temporal signals using singular value decomposition (SVD) and enables locating multiple dipole sources by means of a scanning procedure. Examples of subspace source localization methods include MUSIC and FINE, either of which can be used to locate the internal generators of seizures in source space.

MVAR modeling can be used to model the time series of these identified sources. DTF can be used to characterize the causal interactions in the spectral domain among multiple sources obtained from FINE based on the MVAR modeling. The causal relationships among multiple sources from the outputs of DTF can be used to identify primary sources. A primary source is a source responsible for seizure onset and is at the start points of the topographical links of directional causal interactions.

The source analysis can be performed using clinical recorded ictal rhythms.

### Method—Spatio-Temporal Source Localization: FINE

In one example, the source model used in subspace source localization is the equivalent current dipole, which represents an idealized point source. Due to the linearity of Maxwell's equations, the forward model for arbitrary source configurations can be written as a linear superposition of forward models for these point sources. A set of measurements along the time axis can further be written in matrix format as:

φ( t̅)=A(R,Q)S( t̅) (Eq. A-1)

Here, φ is the spatio-temporal measurement on multiple EEG electrodes and S is the source temporal behavior matrix. A is the lead field matrix where R is a set of location vectors, r̅, for multiple arbitrary source configurations and Q is a set of their associated orientation vectors, q̅. The electrode positions and the geometric shape and conductivity profile for each specific head model are assumed to be fixed in order to simplify the denotation in the equations.

The concept of subspace source localization is based on calculating the subspace correlation (SC) between dipolar topographies, i.e. A( r̅, q̅) corresponding to a particular dipole and an estimated signal subspace or noise-only subspace. By applying SVD to the data matrix, φ=UAV^{T}, the measurement space can be partitioned into the signal subspace Uₛ and the noise-only subspace Uₙ. The p-dimensional signal subspace includes the columns from U whose corresponding singular values l . . . p lie above the noise level. The noise-only subspace includes the rest columns with dimension of N-p, where N is the number of electrodes. The SC metric for the classic subspace source localization can thus be defined against the noise-only subspace as:

$${SC}_{MUSIC}^{2} ( \overline{r} ) = {min}_{q} ( \frac{{A ( \overline{r} , \overline{q} )}^{T} {U}_{n} {U}_{n}^{T} A ( \overline{r} , \overline{q} )}{{A ( \overline{r} , \overline{q} )}^{T} A ( \overline{r} , \overline{q} )} ) \qquad ( Eq . A \text{-} 2 )$$

Sources are defined as those for which the scanning metric SC_{MUSIC}( r̅) is sufficiently close to zero. In the FINE (First Principal Vectors) method, for each scanned point, a region Θ (which surrounds the scanned point) can be found and a small set of vectors in the noise-only subspace (denoted by FINE vector set F_{Θ}) can be identified as an intersection set between the noise-only subspace and the array manifold spanned by the specific region Θ, based on the concept of principal angles. The SC metric for FINE can thus be expressed as

$${SC}_{FINE}^{2} ( \overline{r} ) = {min}_{q} ( \frac{{A ( \overline{r} , \overline{q} )}^{T} {F}_{Θ} {F}_{Θ}^{T} A ( \overline{r} , \overline{q} )}{{A ( \overline{r} , \overline{q} )}^{T} A ( \overline{r} , \overline{q} )} ) \qquad ( Eq . A \text{-} 3 )$$

Using F_{Θ}over Uₙ is advantageous under conditions with low signal-noise-ratio (SNR), high source correlation, and small inter-source distances in computer simulation studies. Spatio-temporal source localization, in accordance with the present subject matter, can be performed using, for example, MUSIC or FINE. The quality of the source waveform reconstruction, MVAR modeling, and DTF causality estimation, depends on the accuracy of the subspace source localization. The FINE subspace source localization method may be more accurate than MUSIC under certain conditions, and thus may mitigate possible error propagation and accumulation.

Sources can be found as those for which the scanning metric for FINE is sufficiently close to zero. The orientation of each source is defined by the q̅ value which minimizes the scanning metric at a source location. It can be obtained by transforming Eq. A-3 into a generalized eigen-decomposition problem.

With the known multiple locations, R, and the corresponding orientations, Q, of the multiple estimated dipole sources from Eq. A-3, the lead field matrix A can be constructed for these dipoles. The source waveforms can be calculated by S=A⁺φ, where A⁺=(A^{T}A)⁻¹ A^{T}.

### Method—- Multivariate Autoregressive Modeling (MVAR)

Let S=[ s̅₁(t), s̅₂(t), . . . , s̅ₖ(t)]^{T} be a set of source waveforms from the output of FINE. Here t refers to the time index and k the number of estimated sources. Assume that the following MVAR process is an adequate description of the data set S:

$$S ( t ) = {\sum }_{i = 1}^{p} Λ ( i ) S ( t - i ) + E ( t ) \qquad ( Eq . A \text{-} 4 )$$

where S(t) is the data vector in time; Λ(i) are matrices of model coefficients; E(t) is a vector of multivariate zero-mean uncorrelated white noise; and p is the model order. The optimum order, p, of a MVAR model is generally chosen as the optimizer of an order selection criterion. In one example, Schwarz's Bayesian Criterion (Schwarz 1978) is used. Model coefficients Λ(i) are computed by a stepwise least squares algorithm for high-dimensional data set.

### Method—Directed Transfer Function (DTF)

After the model order and coefficients for a MVAR model are adequately estimated, Eq. A-4 can then be transformed into the frequency domain:

Λ(f)S(f)=E(f) (Eq. A-5)

where

$$Λ ( f ) = {\sum }_{i = 0}^{p} Λ ( i ) {e}^{- j 2 π f i Δ t}$$

with Λ(0)=−I -. Eq. A-5 can be rewritten as:

S(f)=Λ⁻¹(f)E(f)=H(f)E(f) (Eq. A-6)

where H(f) is the matrix transfer function of the system, f is frequency and Δt is the sampling interval. The DTF function, γᵢⱼ²(f) is defined by the elements of the transfer matrix in the spectrum domain which describe the directional causality from source j to source i:

$${γ}_{ij}^{2} ( f ) = \frac{{\vert {H}_{ij} ( f ) \vert}^{2}}{{\sum }_{m = 1}^{k} {\vert {H}_{im} ( f ) \vert}^{2}} \qquad ( Eq . A \text{-} 7 )$$

The DTF values are in the interval of [0, 1] and the normalization condition

$${\sum }_{m = 1}^{k} {γ}_{im}^{2} ( f ) = 1$$

is applied. The DTF causality is a function of frequency and the statistical significance test for it is performed over a selected frequency band which covers the major ictal rhythms.

### Method—Statistical Assessment of Causality: Surrogate Test

The DTF function has a highly nonlinear relation to the time series data from which it is derived. In one example, a nonparametric statistical test technique using surrogate data is used. In one example, the time series data from source data set is randomly and independently shuffled to create a surrogate data set. In one example, the Fourier transform (FT) of the time series is computed and the magnitudes of the Fourier coefficients are held constant while the phases of the Fourier coefficients are randomly and independently shuffled. The inverse FT returns to the time domain to generate a surrogate data set.

A MVAR model can be generated and fitted to this surrogate data set and the DTF causality can be estimated from the model. The shuffling procedure destroys the temporal structure in the data while preserving the spectral structure of the surrogate data as the original time series. After repeated shuffling, for example, 5000 times, an empirical distribution for the DTF causalities can be created under the condition that null hypothesis of no causality is true. Using this distribution, the present subject matter allows assessment of the statistical significance of the DTF causality evaluated from the actual source time series.

### Example—Patients and Data Acquisition

In one example, a group of five patients with medically intractable partial epilepsy are evaluated for surgery using an example of the present subject matter. The method includes recording EEG data for each patient using 31 electrodes in a modified 10/20 system. The EEG data is collected continuously using a C_{z} reference montage at a sampling rate of 200 Hz with a bandpass filter of 1.0 to 35 Hz, which covers the EEG frequency of the most seizures (3-29 Hz). The positions of electrodes as well as the positions of 3 fiducial points on the head (nasion and left and right preauricular points) can be digitized using a handheld magnetic digitizer.

In one example, the patient is subjected to a standardized seizure protocol magnetic resonance imaging (MRI) to demonstrate a potentially epileptogenic structural abnormality. The MRI can be acquired using a 1.5 Tesla system executing a SPGR sequence (TR=24 ms, TE=5.4 ms) with a 220 mm field of view. The 120-coronal-slice protocol produces a voxel dimension of 0.9375×0.9375×1.6 mm. A trained EEG technician can perform the ictal injection of 99 Tcm-ECD during the patients' habitual seizures. The injection is performed as soon as possible after seizure onset. The interictal injection is performed when the patient has been seizure-free for at least 24 hours. Single photon emission computerized tomography (SPECT) images can be acquired between 2 to 3 hours after isotope injection using a Helix systems gamma camera. The interictal and ictal images can be subtracted using a brain surface matching algorithm and regions exceeding two standard deviations can be co-registered onto the patients' MRIs.

### Method—Ictal Source Analysis

The scalp EEG and video monitoring can be reviewed for the occurrence of ictal rhythms via visual inspection, and the time points of ictal onset can be determined by experienced epileptologists. In one example, 23 seizures (2-8 per patient) were identified and 3 of them were rejected for ictal source analysis because of too many artifacts during the ictal onset period. Analysis of 20 seizures (2-7 per patient) from this group are summarized in Table A-1.

Table A-1 includes a summary of the ictal source identification results in five patients, with comparison of the estimated primary sources to visible MRI lesions (or pathological sites for Patient #5). ++: sources within or on the edge of the MRI visible lesions; +: sources in the vicinity (<1.5 cm) of the MRI visible lesions; −: sources far away from the lesion; ×: rejected trials. The primary sources in 20 seizures appeared either within or on the edge of the lesions or very close to the lesions. There is no single seizure with primary sources completely outside of the lesions.

TABLE A-1

| | Patient | Patient | Patient | Patient | Patient |
|---|---|---|---|---|---|
| | #1 | #2 | #3 | #4 | #5 |
| ++ | 2 | 1 | 5 | 5 | 4 |
| + | 0 | 1 | 2 | 0 | 0 |
| − | 0 | 0 | 0 | 0 | 0 |
| x | 0 | 0 | 1 | 2 | 0 |
| Total | 2 | 2 | 8 | 7 | 4 |

FIG. A-1 (upper) shows an example of the 31-channel scalp waveforms from Patient 1 for a 10 second period. The temporal evolution of ictal rhythms can be examined using time-frequency representation (TFR), which convolutes signal by complex Morlet's wavelets and provides a time-varying energy of signal in each frequency band as shown in FIG. A-1 (lower). The vertical black bar on the channels indicates the ictal onset time point for this patient as determined by an epileptologist. The build-up process of the seizure occurrence can be observed after the ictal onset. In one example, and for MVAR to model ictal sources, the selected ictal onset segment is quasi-stationary. The channel waveforms and TFR drawn in FIG. A-1 were used to segment the appropriate ictal onset period for subsequent ictal source analysis. For instance, in FIG. A-1 any of the first 3 seconds provide suitably quasi-stationary data since it exhibits no obvious abrupt transition. Generally, longer data provides more accurate subspace source localization and dynamic causality estimates. The entire 3-second FIG. A-3A data is used for the ictal source analysis.

The layered realistic geometry inhomogeneous head model, which includes three conductivity boundaries, including the interfaces between the air and scalp, the scalp and skull, and the skull and brain, can be used. The segmentations of the scalp and skull can be performed on the MRI images for each subject using software. The subject-specific head models are then constructed based on the segmentation results. Coregistration of the recording electrodes can be achieved by matching the location of 3 fiducial points (nasion and left and right preauricular points) on the MRI to the digitized coordinates of these points. The conductivities for the scalp and brain tissue are 0.33/Ω.m, and the conductivity ratio between the brain and skull is 1:1/20.

### Signal Subspace Illustration

FIG. A-2 shows a curve for the singular values from the SVD of ictal data for Patient 1 (FIG. A-3A) along with the scalp potential patterns for the first four largest singular values (up-down sequence), which belong to the signal subspace. Although the noise-only subspace is used in Eq. A-2 and Eq. A-3, for illustration purposes, the complementary signal subspace can be used. The figures show that the signal subspace from this ictal data includes the activities in the right temporal and frontal lobes, which are consistent with the results from the ictal source analysis shown in FIG. A-3. The curve for the singular value can be used to decide the order of signal subspace (the p value). The p value in this case was chosen as 4, however, other values are also contemplated, including more conservative choices, such as for example, 5 or 6, and yet not change the source localization results significantly.

FIG. A-3A illustrates a 3-seconds-long 31-channel scalp waveforms from FIG. A-1 for subspace source localization analysis. FIG. A-3B illustrates an example of a 3D scanning result by FINE for an ictal activity (FIG. A-1, Patient #1) displayed with gray MRI slices. The pseudo-colors show the reciprocal of subspace correlation (SC). Red: low SC; Blue: high SC. The extent of pseudo-colors indicates the coverage of the possible solution space. Three identified sources in the 3D scanning are marked with red, blue, and green dots, respectively. FIG. A-3C illustrates locations (pseudo-colors on MRI images), waveforms (green curves, denoted 10A, 10B, and 10C), and causality patterns (big arrows) for identified sources from FIG. A-3B.

### Ictal Source Distributions and Dynamics

The FINE method can be used to scan the possible solution space in a three-dimensional (3D) brain volume. FIG. A-3B illustrates an example of the 3D scanning for the seizure activity (FIG. A-3A) from Patient #1. The pseudo-colors displayed with gray MRI slices show the reciprocal of subspace correlations against the FINE vectors at each scanned point within the solution space. The red color indicates the low subspace correlations while the blue color indicates the high subspace correlations. In one example, a value of 5% is used as the threshold of subspace correlation for FINE, which means that any value below this threshold can be regarded as a possible source. In an example using the discrete dipole source model as the basis, another criterion for a source at a scanned point is that the subspace correlation of the point is at a local minimum in the 3D tomography of subspace correlations. The source points in the 3D tomography are searched and analyzed and three sources are identified in this particular example (FIG. A-3B) and are marked with red, blue, and green dots.

FIG. A-3C illustrates the location of these three sources together with the structural MRI. In 20 analyzed seizures from five patients, single or multiple source(s) were identified by FINE, which exist in areas either near to or far from the MRI lesions. For Patients #2-5, the examples are shown in FIGS. A-5A to A-5D, respectively. Those cases with multiple sources (FIG. A-3C and FIG. A-5) were subject to causal interaction estimation. The reconstructed source waveforms in the time domain are shown in FIG. A-3C and FIG. A-6 with green curves (denoted 10A, 10B, and 10C). The MVAR models can be used to model these reconstructed source waveforms and the model orders from total 20 ictal activities ranged from 5 to 22, which is sufficiently small as compared with the time points for each waveform (around 600) to achieve accurate MVAR modeling. The amplitudes of source waveforms indicate the integrated source strengths over the focal brain areas responsible for ictal activities. One example of the present subject matter uses ideal discrete point dipole sources as a model.

### Ictal Source Causal Interaction Patterns

FIG. A-4B illustrates the DTF causality values for the three sources as shown in FIG. A-3 for Patient #1. The figure illustrates plots of the statistical significance of the DTF causality as a function of frequency. The thin curve in each small box of FIG. A-4B depicts the varying directional DTF causalities along the axis for frequency. The upper two histograms illustrate an interaction pattern from the red-dotted source to the other two sources. The middle two histograms are with respect to the blue-dotted source and the lower two histograms are with respect to the green dotted source. The surrogate data strategy discussed above is used to examine the statistical significance of these causality values. FIG. A-4A illustrates an example of the empirical distribution of the surrogate DTF function values as a function of frequency (note that the plot does not cover the entire DTF function value interval [0, 1], because of its less informative contents at the tails of the distributions). The red curves indicates the significance level of p=0.05. That is, set the achievable highest significance at 1/5000 (i.e. p=0.0002) since the DTF distribution was reconstructed by 5000 repeats. For Patient #1, note that significant (p<0.05) bidirectional information flows between the red-dotted source and blue-dotted source. In this example, only unidirectional information flows from either the red-dotted source or the blue-dotted source to the green-dotted source.

This flow of directional information forms a causal interaction topography, and each link within the topography is shown with large arrows, as in FIG. A-3C for Patient #1, together with other source information such as locations and waveforms. The two-tail arrow means bidirectional information flow, while the one-tail arrow indicates unidirectional information flow. The starting points of the topography are regarded as the primary sources in the obtained causal interaction pattern, and other nodes in the topography are considered as the secondary sources. In this example, the red- and blue-dotted sources are the primary sources and the green-dotted source is the secondary source. The source causal interaction topographies are also shown in FIG. A-5 for other patients. In these examples, Patient #2 has two sources in the right frontal lobe with unidirectional information flow. Patient #3 has three sources in the right frontal lobe, with directional causal interactions from the first source within the lesion (left top) to the second source (left bottom) and then to the third source (right), both of which are in the vicinity of the lesion. Patient #4 has three sources (two in the right mesial temporal lobe and one in the left frontal lobe), and the bidirectional causal interaction was estimated between the two sources within same lobe. The unidirectional causal interaction was found from one source in the mesial temporal lobe (top right) to the source in the left frontal lobe. Patient #5 has two sources in left mesial temporal lobe with unidirectional causal interaction.

### Comparison Between Ictal Source Analysis, MRI, And SPECT

The primary sources identified from FIG. A-3C and FIG. A-5, after ictal source localization and causal interaction estimation, are shown together with MRI images in FIG. A-6 for all five patients. In FIG. A-6, the first row of images shows MRI slices with clear lesions in the first four patients (marked with red circles) and a coronal MRI slice for Patient #5 to show the mesial temporal lobe and hippocampus, which are considered to be the pathological sites for this patient. The second and third rows, if more than one primary source is available, show the locations of the primary sources for ictal activities from all five patients. The consistency between the primary ictal source and MRI lesion is indicated for the first four patients. For the last patient, the locations of the estimated primary sources are consistent with the presurgical evaluation. Furthermore, the SPECT scan performed on this patient also indicates left mesial temporal epilepsy. The positions of the primary sources identified from the entire 20 seizures relative to the visible lesions (or pathological sites for Patient #5) are summarized in Table A-1, which is classified into the following three categories: sources within or on the edge of the visible lesions (++), sources in the vicinity of the visible lesions (+), and only sources far away from the lesion (−). The primary sources from all seizures appeared either within or on the edge of the lesions or very close to the lesions.

FIG. A-7 shows the epilepsy source localization comparison between the ictal source analysis and SPECT imaging for Patients #1 and #2. Because the isotope injections during the SPECT imaging were performed approximately 30 seconds after the ictal onset, the ictal data around the injection time was selected to perform ictal source localization analysis for the purpose of comparison. In Patient #1, bilateral sources in both hemispheres are identified by SPECT scan. Two ictal sources are close to the two SPECT image sources. The source in the left hemisphere, which is far away from the MRI lesion, for this patient was not present in the ictal onset source analysis (FIG. A-3), which suggests that it was generated by the propagation of seizure activities due to the injection delay. Similarly for Patient #2, most of the activities in the SPECT images can be identified in ictal source localization analysis. Some of the primary sources are found in ictal onset source analysis, e.g. the source in the right frontal lobe, and the rest are considered to be caused by propagation, e.g. the sources in the right or left temporal lobes.

### Ictal Source Analysis

The EEG and MEG source localization and imaging techniques have advanced understanding of seizures from the sensor space to the source space. However, the additional requirement for ictal source analysis in epilepsy patients is the distinction between the primary sources which initiate the ictal activity and the secondary sources which are due to propagation. The traditional methods judge ictal onset and propagation by the inspection of EEG traces and then do source analysis to find their responsible underlying generators. The disentanglement of ictal onset and propagation involves preprocessing in either time domain or frequency domain. However, the sources at ictal onset and after ictal propagation may already be entangled when they appear in the scalp EEG measurements, and their frequency components normally occupy similar bands.

Sources identified by source localization and imaging techniques should include all sources responsible for both seizure onset and propagation. Those sources at the starting points of the directional causal interaction topography (FIG. A-3C and FIG. A-5) are considered as primary sources.

The present subject matter combines source localization with spectral causal interaction estimates to enable understanding of the structure of seizures.

### Source Modeling and Subspace Source Localization

The equivalent current dipole model can be used for modeling focal sources, as in focal partial epilepsy. The dipole source model is limited to only providing the source location for the gravity point instead of the entire activated area.

Other source localization and imaging technologies based on distributed source models can also be used. Information flow estimate technologies operating on source space (e.g. cortical current density estimated from the evoked potential rather than spontaneous EEG) can be used with the distributed source model. In addition, the tomography obtained in subspace source scanning can be used to analyze source extent using thresholding techniques according to the present subject matter. The equivalent current dipole source model can be used to estimate dynamic waveforms, thus enabling causal interaction estimation. According to one example of the present subject matter, waveforms for a source with extent can be described by averaging the waveforms for a region of interest (ROI). Subspace source localization can treat spatio-temporal measurements efficiently without data preprocessing and modeling to obtain a single map for subsequent source analysis. Other source localization and imaging methods can also be used including those used in cortical connectivity analysis.

### MVAR Modeling

The MVAR modeling enables spectrum based analysis, including spectrum power, coherence, and causality, for stationary stochastic processes. It parameterizes the multiple time series system into a series of coefficient matrices, (Eq. A-4) and these parameters can be used to characterize the dynamics of multiple time series and their spectral features. The temporal dynamics are held stationary to improve model accuracy for multiple time series. In one example, the ictal onset data segment is selected to avoid rapid activity pattern transitions in scalp EEG waveforms in order to maintain quasi-stationarity. This can also be used with ECoG data. The present subject matter allows modeling by MVAR to avoid raid activity transitions of the EEG recordings. Examples of the present subject matter use an autoregressive process to model the source system or to model the system formed by a group of field measurements at different recording sites.

### Statistical Assessment

An example of the present subject matter uses various statistical tests to assess the statistical significance of results obtained in each step of ictal source analysis, including validation of EEG and MEG mapping techniques. The square of the subspace correlation can serve as the “R-squared” statistic, which indicates the variance of the topography generated by a dipole source identified in the measurement data. The subspace correlation threshold of 0.05, is a conservative choice which explains, from the signal subspace, approximately 90% of the variance in the topography generated by a dipole source. The statistical significance of the DTF causality can be tested using surrogate data strategy. The equivalence between the Granger causality and DTF causality indicate that the causality values from the DTF function themselves are with statistical means.

### Different Imaging Modalities in Epilepsy Patient Evaluation

A variety of non-invasive epilepsy patient evaluation technologies can be used to develop a clinical hypothesis about the location(s) of the epileptogenic zone. Examples include MRI, SPECT, PET, video scalp EEG, and seizure semiology. The various imaging modalities in clinical epilepsy evaluation can be viewed as complementary rather than competing modalities.

The outcomes from ictal source analysis, MRI, and SPECT for the five epilepsy patients in the present example are summarized in Table A-2.

TABLE A-2

| | | | Ictal source |
|---|---|---|---|
| | MRI lesions | SPECT | analysis |
| Patient 1 | Right frontal | Right and left | Right frontal |
| | cavernous | frontal | |
| | hemangioma | | |
| Patient 2 | Right frontal tumor | Mainly right | Right frontal |
| | | frontal and right | |
| | | anterior temporal | |
| | | tip | |
| Patient 3 | Right frontal abscess | Mainly right | Right frontal |
| | with residual | frontal | |
| | encephalomalacia | | |
| Patient 4 | Right mesial temporal | Right temporal | Right medial |
| | sclerosis | | temporal |
| Patient 5 | Normal MRI | Left temporal | Left medial |
| | | | temporal |

The present subject matter enables ictal source analysis and localization of epileptogenic zone. The ictal source analysis is useful when no explicit structural abnormalities exist. The temporal resolution provided by the present subject matter enables distinguishing the primary source from the secondary source. The ictal source analysis of the present subject matter can be used for interictal analysis.

### Additional Examples

FIG. A-8 illustrates a block diagram of system 100 according to one example of the present subject matter. In the figure, input interface 130 is configured to receive sensor data from a brain. In system 100, sensor array 120 includes a plurality of sensors configured to be worn externally by a patient. In other configurations, sensor array 120 includes intracranial sensor array. Network 110, also coupled to input interface 130, enables remote access to the present subject matter. In this configuration, data from a remote location, derived from sensors coupled to a patient or derived from stored data, can be processed and analyzed by the present subject matter.

Input interface 130 is coupled to computer 140. Computer 140 includes a processor and is configured to execute one or more algorithms as described elsewhere in this document. In various examples, the algorithm executed by computer 140 is configured to analyze connectivity, activation, propagation, source localization, or other algorithm as described herein. Other examples include executing a FINE or MUSIC algorithm, or performing DTF, or MVAR analysis. Computer 140 is coupled to control 150. Control 150 can include an operator's console, a keyboard, a touch-screen, a mouse, or other controller to enable an operator to manage the functions performed by computer 140. Computer 140 is coupled to memory 160. Memory 160 can include removable or non-removable memory and examples include a hard disk, a flash memory, a CD-ROM, or other such device. Computer 140 is also coupled to output interface 170. Output interface 170 can include apparatus to couple computer 140 to a user-accessible transducer such as display 180 or other output device 190. Examples of output device 190 can include audio speakers, a network connection, a touch-screen display, a storage device, and a robotic system (configured to manipulate an intervention apparatus).

In one example, the system includes a subset of those elements illustrated in FIG. A-8. For example, one system includes computer 140 coupled to input interface 130 and output interface 170.

FIG. A-9 illustrates a flow chart of method 200 according to one example. At 210, method 200 includes receiving measured data. The measured data can be received by direct electrical connection with a sensor or array of sensors, or received by a connection to a network (wired or wireless). Other examples include receiving data using a removable storage device or by receiving manually entered data. At 220, the method includes receiving a model. The model can include a dipole model, a multipole model or other model as described herein. The model can include parameters. In one example, the model corresponds to the brain. At 230, the method includes determining a result which can include determining a source location, a causality pattern, an activation map, a solution to an inverse problem, or other result. Various algorithms and methods are described in this document, any combination of which can be performed at 230 in the figure. In one example, the method of 230 is performed by a processor or a computer. At 240, the results are provided. This can include storing data or presenting an image or visual representation of the result in a human perceivable manner. For example, the result can be presented on a printer or on a display.

The present subject matter analyzes connectivity of multiple source locations using, for example, FINE. Assessing connectivity entails determining primary and secondary sources. The connectivity, or direction of propagation, between sources can be unidirectional or bidirectional.

An example of the present subject matter can be considered in two parts. A first part is concerned with combinations of connectivity. As such, a threshold provides a basis for comparison to determine connectivity. The present subject matter enables analysis of a three dimensional volume model and is operable in a clinical setting to facilitate diagnosis of epilepsy, for example.

A second part includes activation mapping to determine how the multiple sources communicate over a period of time. This entails a direct reading of the brain over an epoch-based view. In particular, signal propagation within the brain is substantially more rapid than that of the heart. The analysis, according to this part, includes evaluating peak amplitude values or other metric to provide neural activation mapping. Poisson's equations, and Maxwell's equations to some extent, may not fully explain the measured data for the brain. This indicates that the propagation of neuronal activation in the brain may not be instantaneous. The present subject matter is configured to discern propagation occurring in a very short time period, such as that found in the brain.

The present subject matter can be implemented using invasive or non-invasive data collection. One example includes electrocorticography (ECoG), in which an electrode is placed directly on cortical grey matter of the brain in order to record electrical activity directly from the cerebral cortex. Measured results are then analyzed to solve the inverse problem (finding the internal sources responsible for the potentials measured at the scalp).

The following describes one method for connectivity analysis:

1. Receive a set of electrical or magnetic measurements corresponding to electrical activity for the organ. The organ can include a heart, a brain, a stomach, a muscle, a spinal chord, or other organ in which a signal propagates.

2. Access a source model for analysis. The source model can include a dipole model, a multipole distribution, a distributed source model, or a current density model. Other models are also contemplated.

3. Execute an algorithm to solve the inverse problem in order to estimate temporal dynamic distribution of the source, the solution is based on the set of measurements and the source model.

4. Execute an algorithm to analyze connectivity. Connectivity analysis can include performing DTF or other method to determine a connectivity pattern in the source space domain. The connectivity analysis describes activation or propagation within the organ.

5. Determine a parameter that describes connectivity as to a pair of sources. Repeat the calculation for other pairs of sources in order to discern primary source(s) and secondary source(s). For example, with epilepsy, the parameter corresponds to a connectivity pattern within the brain.

Analysis of connectivity enables distinguishing how multiple sources are correlated to each other. For example, two sources may have a high or low incidence of correlation. In various examples, the connectivity can be described as a relationship akin to master-slave, slave-master, or peer-to-peer.

Propagation, or activation, describes unilateral movement from one region to another. The movement can be associated with, or without, temporal delays (for some directions). If there is no delay, then propagation can be viewed as connectivity.

Various methods can be used to determine connection patterns, including the following two examples.

In a first example, connection patterns are analyzed without assuming a specific model of the brain. An example includes DTF where the calculation considers multiple brain regions at a specific frequency component.

In second example, the connection patterns are analyzed using a structural equation model method in order to determine a parameter set. In structural equation modeling, observed variables are understood to represent a small number of latent constructs that cannot be directly measured but are inferred from the measured variables.

The threshold values are derived using a statistical property involving the power spectrum in which the phase is shifted a large number of times. In one example, the phase is shifted approximately 5,000 times for each particular frequency in a process called multivariate analysis. In one example, rather than shifting phase, the analysis is performed by shifting another parameter or by performing the analysis in the time domain.

The present subject matter can be implemented in the clinical environment and applied to the diagnosis, treatment, and monitoring of various disorders or conditions, including, for example, epilepsy, Parkinson's disease, or other neurological disorders. For example, a particular therapy regimen may be selected based on the results of analysis described herein and the regimen is selected because it may be noted for affecting a particular region of the brain.

Part B: Cortical Activation Mapping of Epileptiform Activity Derived from Interictal ECoG Spikes

An example of the present subject matter includes a cortical activation mapping (CAM) method to obtain the neuronal activation sequences from cortical potential distributions.

One example includes analyzing interictal ECoG recordings to find the cortical activation maps, which are then compared with the seizure onset zone identified from ictal ECoG recordings. Various relationships between the local activation time and cortical potential are assumed. In one example, a relationship can be determined by accessing their capability to predict the seizure onset zone. Computer simulations using a moving dipole source model can be conducted to test the method of imaging the propagated cortical activity. In one example, the method is applied to a group of 8 pediatric epilepsy patients.

In both clinical data analysis and computer simulations, the maximal amplitude serves as a criterion to determine the local cortical activation time. As such, the present method has been demonstrated to successfully predict the seizure onset zone in 7 out of 8 patients by the CAM analysis of ECoG-recorded interictal spikes (IISs). For patients with multiple seizure foci, each focus can be revealed by analyzing IISs with different spatial patterns.

The time difference between spike peaks of the interictal events in the leading channel and other channels can be defined as the local cortical activation time. A cortical activation mapping method, based on this time latency, can be used to predict the seizure onset zones and to facilitate presurgical evaluation for the epilepsy patients.

### Introduction

The interictal spike (IIS) can be used to locate epileptiform activity. It can be assumed that regions displaying the largest amplitude of spikes are within the epileptogenic zone and consequently such regions should be resected if possible to render the patients seizure free. However, the IIS may propagate from their initial sites by uncertain neural pathways. Therefore it cannot be concluded that the potential amplitude distribution at the spike peak best represents the character of the spike source unless the distribution does not change with temporal evolution of the interictal discharge.

Consider the distinction between primary and propagated spikes. Rapid propagation of IIS may occur during the discharges. Discerning where the IIS starts and how it propagates may be helpful in order to accurately locate its generators. The identification of brain regions initiating the epileptiform activities can be potentially used to reduce the resection area.

Experiments can be designed to evaluate the initiation and propagation of the epileptiform activity. Both depth and surface electrodes can be used to record the interictal discharges, where the results regarding latency and spatial distribution suggest that relatively large areas of neocortex and archicortex can be simultaneously or consecutively activated through fast association fibers or propagation along the cortex during interictal activities. Spontaneous epileptiform activity can be initiated in various cortical layers on neocortical slices harvested from rats. The activations may start from a small area and spread smoothly from the initiation site to adjacent cortical areas, suggesting that the initiation site is very confined to one of the cortical layers. Laminar analysis of human interictal spikes may show that the cortical layer where the initial depolarization occurs may differ according to whether the IIS is locally generated or propagated from a distant location. The initiation and propagation of the IIS may be helpful in assisting presurgical assessment.

The present subject matter includes an activation mapping method to image the neuronal propagations from subdural ECoG recorded during interictal spikes. Performance can be evaluated by comparing the results with the patients' seizure onset zone identified from ECoG ictal recordings and surgical outcomes. For pediatric patients, the subdural ECoG recording may be appropriate because children usually have superficial neocortical epileptogenic foci close to the subdural recording surface, thus generating much less deviation than those foci located in deep structures such as the hippocampus or amygdala.

### Example Materials and Methods

Eight pediatric patients (3 female, 5 male, 6 to 16 years old, Table B-1) with medically intractable partial seizures were considered. Preoperative MRI/CT scans, interictal and ictal long term video/EEG monitoring were conducted. Among the patients of this example, postoperative diagnosis showed that 7 of them had two epileptogenic foci and 1 of them had single focus, and all patients had extratemporal seizure focus (including frontal, parietal and occipital lobes) no matter how many brain areas were involved in the seizure generation.

TABLE B-1
Summary of patients in the present example.

| Patient | Age | Gender | # Res. | Operation* | Outcome** |
|---|---|---|---|---|---|
| 1 | 8 | F | 2 | RT, RP | SSR |
| 2 | 6 | M | 2 | LF, LP | SF |
| 3 | 7 | M | 2 | LF, LP | SSR |
| 4 | 16 | M | 1 | LF, LT | SF |
| 5 | 12 | M | 2 | RF, RP | SF |
| 6 | 12 | F | 2 | LF, LO | SSR |
| 7 | 10 | F | 2 | LP | SSR |
| 8 | 11 | M | 1 | LO | SF |

*L—left, R—right, T—temporal, P—parietal, F—frontal, O—occipital
**SSR—substantial seizure reduction, SF—seizure free

Patient #1 had right anterior temporal lobectomy including parahipocampal gyrus, and right pareital topectomy. Seizure frequency was reduced from 10 seizures per week to 2.75 per week, after surgery. Patient #2 had left frontal lobectomy and left pareital topectomy and was seizure free for 2 years. Patient #3 had left frontal and left pareital topectomy, and had 85% seizure reduction after surgery. Patient #4 had left frontal lobectomy and left temporal lobe disconnection and hipocampectomy. The patient was seizure free for 2 years after surgery. Patient #5 had first right subtotal frontal lobectomy right pareital topectomy and 90% reduction in seizure. In the second surgery, the patient had right functional hemispherectomy and was seizure free for 6 months. Patient #6 had left frontal and left occipital topectomies, and had seizure reduction from 30 per month to 2 per week. Patient #7 had left partial occipital lobectomy, and the seizure was reduced from multiple seizures per day to 5 seizures per week. Patient #8 had left occipital lobectomy and was seizure free for 1 year.

For each patient, long term ECoG recordings was inspected for the occurrence of interictal spikes. Only those patients whose interictal ECoG spikes showed time delays greater than 10 ms at various recording sites were considered, so that the latency difference can be determined without ambiguity under the 400 Hz ECoG sampling rate.

### Data Acquisition

During the presurgical monitoring for the epilepsy patients, ECoGs were recorded using multiple rectangular electrode grids (8×8, 8×6, 8×4, etc.) and strips (8×1, 6×1, 4×1) with inter-electrode distance of 8-10 mm placed directly on the subdural surface as part of the presurgical diagnostic evaluation. The ECoG recordings were referenced to the contralateral mastoid, sampled at 400 Hz and band-pass filtered from 1 Hz to 100 Hz. For each patient, multiple interictal spikes were visually identified. A time window of 200 ms centered at the peak of the Global Field Power (GFP) was used to select the spike epochs for further analysis. In cases where larger than 50 ms latency difference were observed, only multi-channel patterns, that were repeatedly recorded, were analyzed in order to exclude the possibility that the large latency differences did not represent recordings from independent asynchronous interictal foci.

### Cortical Activation Mapping

The latency differences among different ECoG recording sites may be caused by neuronal propagation, that is, not due to volume conduction. Unlike cortical current density imaging or cortical potential imaging, which represent electrical current density or potential field distributions over the cortical surface at each instant, cortical activation mapping (CAM) can determine the sequence of propagation of neuronal activation over the surface of the cortex from the spatiotemporal cortical potential distributions. Cortical activation refers to the neuronal activity due to the propagation as observed over the cortical surface. It is not referring to cortical electrical or pharmacological stimulations. Assume a relationship exists between the local neuronal activation time and the cortical surface potentials. By analyzing the subdurally recorded interictal spikes, a relationship can be found in terms of the degree of consistency with respect to the seizure onset and propagation.

The activation time is defined as the time instant when the local tissue is excited. Four criteria can be considered, including using the peak amplitude, the peak first derivative, the peak second derivative and the peak Laplacian as indicators of cortical neuronal activation. In other words, the cortical activation time is determined from the time instant, when the absolute value of (1) the amplitude of ECoG, (2) the first temporal derivative of ECoG, (3) the second temporal derivative of ECoG, and (4) the surface Laplacian of ECoG, reaches the maximum. For these four relationships, each is tested in predicting the initiation and propagation of the epileptiform activities by analyzing the subdurally recorded interictal spikes for eight pediatric epilepsy patients. Assume that the cortical sites which show the shortest latency represents the initiation zone and those cortical sites with later activations are on the propagation pathways of the epileptiform activities.

All ECoG channels are classified into activated or inactivated channels according to their peak activities. A channel is activated if its maximal amplitude exceeds 150% of the background activity. For the activated channels, the four aforementioned criteria are used to determine the local activation times as an estimation of the cortical neuronal activation sequence during the propagation of interictal spikes.

The estimated cortical activation sequences are compared with the ictal subdural recordings. The subdural ictal ECoG recordings were visually inspected to determine the onset zone and the pathway by which the activities spread to neighboring cortical areas. The relationship which led to the most consistent estimation of propagation pattern is considered as the optimal relationship, suggesting it can indicate the initiation and propagation of epileptiform activities.

### Computer Simulations

In addition to the clinical data analysis, computer simulations can be conducted to demonstrate the abilities of different criteria in estimating the cortical activation sequence. The physiological mechanism for the generation of human interictal spikes may be complex. Single moving dipoles can be used to model the generators of interictal epileptiform discharges. Assume a simplified source model to generate the IISs, where a single moving dipole of constant strength travels along a line inside the brain. The 3-concentric-sphere head model can be employed as the volume conductor model to analytically calculate the dipole-generated cortical potential distributions, from which the local activation times are estimated using the four given relationships. The estimated activation sequences can be compared with the traces of the moving dipoles to evaluate CAM analysis based on the source activities. Different source configurations are tested in the computer simulations with various dipole eccentricities and orientations. In one group of simulations, the dipole is assumed to move along the diagonal on the cortical electrode grid with a constant speed. The reference local activation time can be determined by the time when the dipole was closest to the specified cortical sites. The local activation time at these cortical sites can be calculated using the four different criteria. The correlation coefficient can be computed between the reference and calculated activation time. The relationship which gives the most consistent results is considered to represent the optimal relationship between the potential distribution and local cortical activation time.

### Results

The CAM analysis was performed to analyze ECoG recordings during interictal spikes for eight pediatric patients with intractable seizures who either were seizure free or had substantial seizure reduction following surgical resection. For each patient, only the interictal ECoG spikes with at least 10 ms latency difference (4 time points at 400 Hz sampling rate) between the occurrences of peaks at various recording sites were analyzed.

### Cortical Activation Mapping in Patients

The CAM analysis was performed in all eight patients using the four criteria. Typical results from two patients (patient #3 and #5) are shown in FIG. B-1 and FIG. B-2. According to the results from all of the patients (with the exception of patient #6) the peak amplitude criterion returned the most consistent estimate of ictal onset zone (IOZ). The peak first derivative criterion also revealed the initiation zones which surround the IOZ, although it is not as accurate as the peak amplitude criterion. In most patients, the peak second derivative and peak Laplacian criteria did not provide reliable estimates of the IOZ.

FIG. B-1 illustrates cortical activation mapping (CAM) analysis for patient #5. In FIG. B-1A, ECoG waveforms are shown during an interictal spike recorded by 6×8 subdural electrodes. In FIG. B-1B, cortical activation time (CAT) is determined by the time of occurrence of peak amplitude of the ECoG recordings from different channels. In FIG. B-1C, CAT is obtained by the peak first derivative criteria. In FIG. B-1D, CAT is obtained by peak second derivative criteria. In FIG. B-1E, CAT is obtained by peak Laplacian criteria. FIG. B-1F illustrates ECoG recording channels and ictal onset zone (IOZ). Black circles indicate subdural electrodes and pink circles represent the cortical area where seizures started.

FIG. B-1A illustrates an example of an ECoG recorded interictal spike for patient #5. The time latencies can be observed from the occurrence of the spike peak in different channels. Clinical diagnosis found this patient to have had a right frontal seizure focus. FIG. B-1B to FIG. B-1E are the activation time mappings determined by criteria (1)-(4), respectively. From FIG. B-1B and FIG. B-1C, time latencies of about 50 ms among various channels were noted, suggesting the interictal activity initiated from the lower left corner of the electrode plate and propagated to the opposite corner. As comparison, it is unclear where the interictal event started from FIG. B-1D and FIG. B-1E. FIG. B-1F displays the configuration of subdural electrodes and those electrodes marked as pink are the seizure onset identified by examining the ictal ECoG recordings in the same patient.

The results of CAM analysis for patient #3 are displayed in FIG. B-2. This patient had a left parietal seizure focus as shown in FIG. B-2F, where the seizures were identified to initiate from the pink channels numbered 16, 24 and 32. By comparing FIG. B-2B to FIG. B-2E with FIG. B-2F, the activation mapping determined by criterion (1) is most consistent with the IOZ identified from the ictal ECoG recording. FIG. B-2D and FIG. B-2E show disordered activation patterns, where the initiation of the interictal activity is not readily recognized from these patterns.

For patient #6, the cortical area initiating the interictal spikes revealed by CAM analysis was localized in the area adjacent to the IOZ as determined from ictal ECoG recordings. FIG. B-3A shows a typical interictal ECoG waveform in patient #6. Time delays can be observed among the different recording channels from the waveform. FIG. B-3B displays the results by CAM analysis for this interictal spike. The revealed initiation cortical area of the IIS does not overlap with the IOZ, which is represented by the pink electrodes on the enlarged display of the intracranial electrode grid shown in FIG. B-3C, but in an area with about 2 cm distance from the IOZ. The CAM analysis of other IISs in this patient rendered similar results as that in FIG. B-3B. One of the eight patients in this example returned results where CAM analysis does not predict the IOZ.

FIG. B-3 illustrates an example in which CAM analysis does not correspond to IOZ determined from ictal ECoG recordings. FIG. B-3A illustrates waveforms of interictal ECoG recordings from patient #6. FIG. B-3B illustrates CAT map obtained from CAM analysis. FIG. B-3C includes an illustration of IOZ in patient #6 determined from ictal ECoG recordings. Black circles (a subset of which are labeled) are subdural grid electrodes, and pink circles (all of which are labeled) represent IOZ determined from ictal ECoG recordings.

In the present example, seven patients (#1, 2, 3, 4, 5, 6, 7) had two epileptogenic foci located in either the same or different lobes. Inspection of their interictal spikes showed that different spatiotemporal patterns existed among the IISs in the same patient. Clustering of the IISs according to their spatiotemporal patterns may help before the CAM analysis for each type of IIS.

Patient #7 had two seizure foci located in the left parietal lobe as shown in FIG. B-4E. Focus #1 was more anterior and superior than focus #2. Two different patterns of interictal ECoG spikes have been identified for this patient. Pattern #1 involved more anterior and superior parietal activity as shown in FIG. B-4A. The results from the CAM analysis for this type of IISs in FIG. B-4B revealed the location of seizure generator #1. FIG. B-4C shows a typical waveform of pattern #2, which includes the more posterior and inferior parietal activity. The CAM analysis for the IISs with pattern #2 indicated the location of seizure focus #2 as shown in FIG. B-4D. These results suggest that IISs with different patterns can be classified according to their spatial distributions for the patients with multiple seizure foci (6 out of 8 patients in the present example), and then analyzed separately to locate the individual epileptogenic zone.

FIG. B-4 includes an illustration of CAM analysis for patients with multiple epileptogenic foci. FIG. B-4A includes an illustration of waveforms of IIS with pattern 1 in patient #7. FIG. B-4B illustrates CAM analysis of the IIS shown in FIG. B-4A. FIG. B-4C illustrates waveforms of IIS with pattern 2. FIG. B-4D illustrates CAM analysis of IIS shown in FIG. B-4C. FIG. B-4E illustrates two epileptogenic zones have been indicated with blue circles. Focus #1 included channels 3, 4, 11, 12 and 13; Focus #2 included channels 33 and 34.

### Cortical Activation Mapping by Computer Simulations

FIG. B-5 and FIG. B-6 show the results of the CAM analysis from the computer simulations using the protocol described in this document. A single moving dipole oriented either radially or tangentially with different eccentricities (0.60 to 0.85) can be used to generate the cortical potential distributions from which the cortical activation sequences are estimated using criteria (1)-(4). Although only the results from eccentricity of 0.80 are included in FIG. B-5 and FIG. B-6, similar results can be obtained from simulations with other eccentricities. Table B-2 summarizes the results from computer simulations by providing the correlation coefficient (CC) between cortical activation mapping and dipole moving patterns. The maximum amplitude criteria gives consistent estimation of the source movement. FIG. B-5A illustrates the volume conductor, the locations of the cortical electrodes and the trace of the moving dipole. A radial dipole can be assumed to move from the lower left corner to the upper right corner under the grid electrodes. FIG. B-5B illustrates the simulated cortical potential distributions generated by the moving dipole. FIG. B-5C to FIG. B-5F are the activation mapping results on the 8×8 grid pad using four different criteria: maximal amplitude (C1), maximal first derivative (C2), maximal second derivative (C3) and maximal surface Laplacian (C4), respectively.

FIG. B-5 illustrates computer simulation of CAM analysis using a single moving radial dipole. FIG. B-5A illustrates a sphere which represents the outermost surface of the three-sphere head volume conductor; black dots denote cortical electrodes; the pink line represents the trace of dipole moving from lower left corner to upper right corner (endpoints are labeled start position and end position). The eccentricity of the trace is 0.80. FIG. B-5B illustrates cortical potential waveforms generated by the single moving radial dipole. FIG. B-5C through FIG B-5E illustrate cortical activation mapping from potential distributions using different criteria of maximal amplitude (C1), maximal first derivative (C2), maximal second derivative (C3) and maximal Laplacian (C4), respectively.

Considering the dipole was moving from corner to corner at a constant speed, C1 gave the most reasonable estimation of the activation sequence while C2, C3 and C4 generated less accurate or smeared results. FIG. B-6A illustrates the cortical potential waveforms generated by a tangential dipole moving along the same route as shown in FIG. B-5A. FIG. B-6B to FIG. B-6E display the activation maps using C1, C2, C3 and C4 respectively. Although the initiation location is similar in these results, higher spatial resolution can be observed in FIG. B-6B than in the other results shown in FIG. B-6C to FIG. B-6E. Note that C1 gives the most consistent estimation of the dipole source activities than the other criteria.

FIG. B-6 illustrates computer simulation of CAM analysis using single tangential dipole moving from lower left corner to upper right corner with eccentricity of 0.80. FIG. B-6A through FIG. B-6E correspond to conditions similar to those of FIG. B-5A through FIG. B-5E.

TABLE B-2
Correlation coefficient between dipole moving pattern and cortical
activation mappings determined by different criteria

| | | Correlation Coefficient | | | |
|---|---|---|---|---|---|
| | Eccen- | Max | Max 1^{st} | Max 2^{nd} | Max |
| Orientation | tricity | Amplitude | derivative | derivative | Laplacian |
| Radial | 0.60 | 0.9750 | 0.9327 | 0.5754 | 0.4573 |
| | 0.70 | 0.9750 | 0.9387 | 0.6837 | 0.7095 |
| | 0.80 | 0.9747 | 0.9246 | 0.8309 | 0.9159 |
| | 0.85 | 0.9333 | 0.8855 | 0.8858 | 0.8448 |
| Tangential | 0.60 | 0.9441 | 0.9451 | 0.9125 | 0.8354 |
| | 0.70 | 0.9377 | 0.9474 | 0.9111 | 0.8586 |
| | 0.80 | 0.9248 | 0.9477 | 0.9040 | 0.8771 |
| | 0.85 | 0.9103 | 0.8047 | 0.7091 | 0.8114 |

### Discussion

The present subject matter includes, among other things, quantitatively imaging of the cortical neuronal activation sequence during the epileptiforn interictal discharges from multi-channel intracranial ECoG recordings. The present subject matter can be used to identify the initiation and propagation of epileptiform activity. By comparing the results obtained from the CAM analysis with ECoG recorded seizure activities in eight pediatric patients, it appears that the CAM analysis has successfully predicted the IOZ in most cases. The present subject matter can be applied in assisting the presurgical evaluation and surgical planning for patients with intractable epilepsy.

Latency differences of paroxysmal interictal discharges at different recording sites are usually less than 50 ms, and hence are not easily recognized by visual inspection of the ECoG recordings. The present subject matter can quantitatively determine the cortical activation sequence based on the latencies among the spike peaks from ECoG recordings. Cortical regions where the earliest changes of spikes occur indicate the pacemakers of epileptiform activities inside the epileptogenic zone, and these regions may be selected for resection. It appears that the peak amplitude is a good criterion to estimate the cortical neuronal activation sequence from the ECoG recordings.

The strong correlation is noted between the initiation of interictal spikes and the IOZ as epileptogenic pacemaker. For interictal events in patients with temporal lobe epilepsy, results show that the resection of cortical regions with leading spikes results in significantly better surgical outcomes. For extratemporal lobe epilepsy, results show that strictly unifocal interictal epileptiform patterns on the scalp EEG are highly predictive of the IOZ (100% specificity) as well as successful post-surgical outcome (seizure free in 77% patients). The first detectable peak has a high topographic correlation with the epileptic generator. Interictal events are highly predictive of seizure generators and can facilitate locating the epileptogenic zones.

The eight pediatric epilepsy patients of the present example described herein were selected because obvious time latencies (4 time points or 10 milliseconds) were found among various channels in their interictal ECoG recordings, suggesting significant propagation during the interictal discharges. This propagation may occur in a larger population of patients, but it may not be detected under certain sampling rates (400 Hz in the present example). Propagation of the epileptiform activities can be fast and widespread, especially in neocortical epilepsy. In this case, the sequential activation of neuronal population may be misinterpreted as simultaneous occurrences. Increase of the temporal resolution in EEG recordings may facilitate cortical activation mapping.

Irregular potential spatial distributions and significant differences in spike waveforms at different recording sites cannot be explained by the passive spread of volume-conducted electric fields from a distant localized source. Instead, the observations suggest fast and widespread propagation along neural pathways during interictal discharge. Assuming that the spikes recorded at different locations represent synchronous activation of the underlying neuronal population, the peak of the spikes can be interpreted to reflect the onset of neuronal activation regardless of the spatial distributions of potential recordings. By encoding the time latencies into spatial maps, the CAM analysis can generate the topography of neuronal activation sequences, which indicate the primary and secondary sources of epileptiform activities.

The mechanisms of generation of human IIS cannot be readily explained. Some consider that human IIS are homologous to the paroxysmal depolarization shifts (PDSs) in animal models of epilepsy and giant excitatory postsynaptic potentials (EPSPs). On the other hand, different neurophysiological synchronizing mechanisms may be present. Due to the uncertainty of the mechanisms of generation of both interictal and ictal discharges, the physiological relationship between IIS and seizure is not well understood. Questions remain as to if and how the occurrence of IIS can reflect the epileptogenic zone.

The observations as to patient #6 may be explained by the discrepancies in the origin of IIS and seizure, or by the vertical propagation of IIS in the human brain.

The present method uses the 2-dimensional cortical potential distribution to perform the CAM analysis. This is effective for pediatric patients with superficial neocortical epileptogenic foci, but it may generate inaccurate estimation of initiation of IIS in cases where the IIS originates from deep cortical structures. The human IISs may start from cortical layer IV with powerful depolarization in the regions on the main route of ictal propagation, which spread transversely to both supra- and infra-granular laminae. Because of this vertical propagation, the earliest activation detected by the subdural electrodes may actually represent neuronal activity which has propagated away from the initiation site. This misrepresentation is difficult to avoid when using the 2-dimensional potential distribution, and may be corrected by 3-dimensional mapping using depth potential recording or estimation.

The performance of different criteria can be evaluated in imaging the activation sequence by using computer simulations conducted using simplified models to estimate the cortical activation times from the potential distributions (Table B-2). The results shown in FIG. B-5 and FIG. B-6, together with Table B-2, reveal that the maximal amplitude criterion gives the most consistent estimation of the source activation pattern, which is also consistent with the results from clinical data analysis. Note that the single moving dipole is a simplified implementation of generation of interictal epileptiform activity, whose starting location is suggestive of the initiation of IISs and should be resected if possible to generate favorable surgical outcome. In order to fully evaluate the performance by different criteria, simulations can be performed using more realistic source models both physiologically and pathologically.

Note that the quantitative volumes of the performed resections are unclear from the data due to the lack of postoperative MRIs. Such postoperative MRIs may provide a quantitative means of correlating the origin of interictal epileptiform activity with the findings from the CAM analysis. Such quantitative analysis may precisely localize the epileptogenic zones.

For some patients, it appears that the IOZs were located at the edge of the grids (FIG. B-1, FIG. B-2, and FIG. B-4). In this case, the possibility that the recorded epileptiforn activities originate from remote location and propagate to cortex underlying the grid electrodes may be excluded. Clinically this can be accomplished by validating ECoG activity against simultaneous scalp EEG recording which indicate activity significantly beyond the supposed focus.

The present subject matter demonstrates the ability of the CAM analysis to generate the topography of the activation sequence of neuronal populations. The patterns of initiation and propagation of the IISs obtained from the CAM analysis are effective in predicting the ictal onset zone in the pediatric epilepsy patients. The present subject matter may be used to define the epileptogenic zone.

Furthermore, the CAM analysis can be extended to inversely estimated cortical potentials, from noninvasive scalp EEG. This can be done in the following procedures: 1) Estimate the time course of cortical potentials (or current density distribution) from the scalp EEG by solving the inverse problem; 2) apply the above CAM procedure to the estimated cortical potentials or current density to determine the activation time; 3) display the results.

### Part C: Imaging of Complex Neural Activation

Electroencephalography or magnetoencephalography (EEG/MEG) can be used for evaluating transient neuronal activity and its timing with respect to behavior in the working human brain. Direct localization of the neural substrates underlying EEG/MEG can be achieved by modeling neuronal activity as dipoles. Neural source localization using the dipole model is effective in relatively simple localization tasks owing to the very simple model and its insufficiency in differentiating cortical sources with different extents.

The present subject matter includes imaging of complex neural activation using multiple sources of different cortical extensions directly from EEG/MEG. The present subject matter includes additional parameters for the dipole model and can be used for the extended sources confined to the convoluted cortical surface. The localization of multiple cortical sources can be achieved by the use of a spatio-temporal subspace source localization method with the source model disclosed herein. Performance can be evaluated with simulated data as compared with the dipole model. Estimating multiple neuronal sources at cortical areas can be used to describe the cortical electrical activity from simple early sensory components as well as more complex networks, such as in visual, motor and cognitive tasks.

In the context of noninvasive localization of neuronal activity, functional MRI (fMRI) based on the detectable hemodynamic changes can be used for mapping widespread activity within the brain with millimeter spatial resolution. However, fMRI lacks the temporal resolution to observe the transient formation of neuronal assemblies due to the slow hemodynamic response (in the order of second). On the other hand, EEG and MEG directly detect the neuronal electrical changes with millisecond temporal resolution, which provides information on the timing of brain events with respect to behavior. Direct localization and imaging of neuronal activity using EEG/MEG thus becomes attractive. Such task require modeling neuronal activity due to the limited penetration of measurements, and the performance of computational methods, which estimate values of parameters defined in a neural source model, is essentially dependent on the complexity of the localization task.

EEG/MEG measurements are assumed to be generated by a few focal sources, each of which can be modeled as a dipole with parameters for location and moment. This model has been applied to evaluate the neuronal activity occurring within the somatosensory and auditory cortices, and the same model has also been demonstrated, in a group of partial epilepsy patients, to be clinically helpful in assisting their diagnosis and evaluation for surgical treatment. However, neural substrates associated with early sensory response or foci in partial epilepsy are usually of low complexity and can be accurately modeled by 1 or 2 dipoles, which guarantee the success in the above applications. The difficulty faced by the dipole model in localizing complex neural activation is not only from computational methods, but also from source models. Mathematically, the computational methods have trouble finding the globally optimal model parameters for multiple sources since the complexity of the problem increases exponentially with the complexity of the source model, i.e. the number of dipoles. Physiologically, it is believed that EEG/MEG predominantly detects synchronized intracellular current flows in the cortical pyramidal neurons, perpendicularly to the cortical sheet of grey matter. The extents of such current flows have been estimated of at least 40 mm² or possibly even much larger to be observed on EEG/MEG sensors. The dipole model lacks parameters to define this extent information. Furthermore, due to the highly convoluted cortical structure, the observable EEG/MEG fields generated by realistic cortical neural sources are significantly biased from the fields generated by dipoles without extents, which may not be negligible in localization tasks of multiple sources with different extents.

The current density source model, with each small element represented by a dipole, has been developed to reconstruct extended sources on a presumed source space. Compared with the dipole model, the current density source model has significant larger parameter space and the resulting mathematical problem is linear, but highly underdetermined. Its reconstructed current density is usually oversmoothed and spread over multiple cortical sulci and gyri.

The present subject matter includes a source model that extends dipole by accounting for non-negligible spatial extent with a set of higher-order moment parameters additional to those for the dipole, i.e. location and moment, which leads to the multipole model. Although the number of model parameters is increased, the multipole model still retains simplicity as compared with the current density source model. The present subject matter includes a spatiotemporal subspace source localization method using multipole instead of dipole to image complex neural activation of multiple sources with different cortical extents. In one example, the model is applied to EEG data, however, it can also be applied to MEG.

### Results

The efficiency of the multipole model in representing the extended cortical neural sources is compared with the dipole model. The computational method can be tested in localizing multiple sources with different extents using either the multipole model or the dipole model.

### Simulated Data

The cortical neural sources can be simulated on the realistic cortical surface, segmented interface between gray and white matters from a subject's MRI data (FIG. C-1). The surface was triangulated with high-density meshes, which made a single mesh small enough (about 2.55 mm²) to be represented by a dipole. A cortical neural source was reconstructed from a seed triangle mesh and then its extent was increased by adding the neighboring triangles iteratively. The dipole moment at each triangle was perpendicular to the cortical surface and calculated as the multiplication of its area with the dipole moment density, assumed 100 pAm/mm², which is within the range between 25 and 250 pAm/mm² based on electrophysiological measurements. Cortical sources are randomly generated 1000 times. The major patterns of the EEG fields (99% of the total variance) are generated by these cortical sources of different extents (8 levels, FIG. C-2A) by performing singular value decomposition (SVD) on concatenated gain matrices for dipoles at each triangular mesh within the extension of simulated sources.

FIG. C-1A illustrates a model of an enlarged cortical source with its elemental dipoles having their current flows perpendicular to the cortical surface and the illustration of the expansion, at point l, of the potential field at an electrode generated by the cortical source. FIG. C-1B illustrates a cortical source on a subject's cortex extracted from MRI together with related the conductor of the human head and recording electrode layout.

FIG. C-2B, upper panel, shows the number of independent major patterns for simulated sources of different extents, indexed by the number of neighborhoods, which is averaged over the total number of samples, i.e. 1000. Generally, when the source extent increases, the more independent patterns are needed as the major patterns. Variations can also be observed for the sources with same neighborhood, which are caused by different moment distribution complexities from sources at different cortical positions. The major patterns identified by SVD for each cortical source are then subject to subspace correlation (SC) calculation against the dipolar and multipolar fields from the dipole and multipole models, respectively, at the position of seed triangle. The averaged SC values over 1000 samples are shown in FIG. C-2B, lower two panels. The multipole model has nine independent patterns which can account for up to nine major patterns from cortical sources, while the dipole model only has three independent patterns. The SC values may drop below certain threshold value (e.g. 0.99) in some cases before reaching the maximal dimension, which indicates that some major patterns in these cases may not be well explained. A quantitative measure, the upper extent limit of cortical sources that a model can stand for, is calculated for each simulated source under the condition that the SC values for all major patterns of a source are higher than 0.99. The upper extent limits for multipole (lower quartile, median, upper quartile) are about 4, 6, and 7.5 cm² and it is about 0.02, 0.3, and 2 cm² for dipole (FIG. C-2C). The multipole can represent the EEG fields generated by the extended cortical sources. The large variation in this measure appears location dependent (FIG. C-2D). The cortical sources of large upper extent limit are mostly located on the smooth surfaces and those of small upper extent limit appear on the curved structures.

FIG. C-2 illustrates a simulation with FIG. C-2A showing the cortical sources with different extents by adding the neighborhood iteratively. FIG. C-2B, (upper panel) shows the number of major patterns needed to explain 99% variance generated by a cortical source. The horizontal axis indexes ith pattern (i=1, 2, . . . , 7) in a descending order of the corresponding variance and the vertical axis shows the fraction in the total 1000 simulated cortical sources where that the ith pattern is a major pattern. FIG. C-2B, (middle panel) shows SC between major patterns for a cortical source and those generated by a multipole at the seed triangle; FIG. C-2B (lower panel) shows SC between major patterns for a cortical source and those generated by a dipole at the seed triangle. FIG. C-2C illustrates the upper extent limits of cortical sources from multipole and dipole. FIG. C-2D illustrates location dependence of the upper extent limit; gold colored: the cortical sources with small upper extent limit (lower quartile); purple: the cortical sources with large upper extent limit (upper quartile). FIG. C-2E illustrates three simulated cortical sources around the visual cortex with different extents. FIG. C-2F (upper panel) illustrates the detection ratio of multipole (left bar in each pair) and dipole (right bar in each pair) for three simulated sources. FIG. C-2F (middle panel) illustrates average localization errors of the detected sources. FIG. C-2F (lower panel) illustrates average SC values of the detected sources.

To investigate complex neural activations with multiple cortical sources, three temporally independent sources are simulated with the above generation mechanism, within the visual cortex (FIG. C-2E). The extent of the first source was about one third of the other two (54, 149, and 154 triangles for three sources) to simulate the relative large receptive fields in the associated visual cortex than in the primary visual cortex. The simulated EEG data was contaminated by the real noises recorded from a subject in the resting condition and calibrated to 8 dB signal-to-noise ratio. FIG. C-2F illustrates that the subspace source localization method using multipole can accurately localize multiple extended cortical sources. The detection rates for three cortical sources are 100 percentages over 30 repeats, and their average localization errors are 4.6, 1.4, and 3.4 mm for three sources, respectively. Their approximately zero SC values (<0.05) against the noise-only subspace indicate the reliable source identification. The approach with dipole, however, can detect two sources and the average localization error for one of them is larger than 50 mm with low confidence (SC>0.08). The sources uncovered are with large extents while the focal source is successfully detected.

The present subject matter includes a source model for EEG in localizing complex neural activations with multiple cortical sources. The cortical sources have non-negligible extents for two reasons. The first reason is that the conservative estimation of the smallest extent of EEG detectable neuronal activity is about 0.4 cm², suggested by the nominal calculations of the neuronal density and cortical thickness. With the simulated cortical sources of the present subject matter, the dipole model can sufficiently explain the potential fields generated by these sources with the median extent about 0.3 cm², which means that it is not a satisfactory model for at least half simulated sources at randomly selected locations. The multipole model is able to represent most cortical sources with median extent of about 6 cm². The multipole model can represent focal sources, as the simulation in the present example shows (FIG. C-2B), by controlling the values of model parameters. The second reason is due to the complicated cortical structure, which makes the cortical source moments changing rapidly even within small ranges. The upper extent limits thus exhibit certain variations at the different cortical locations. Generally, at the cortical areas with large curvatures, e.g. ridges of gyri and bottoms of sulci, the upper extent limits are relatively smaller than those areas of smooth surfaces, e.g. walls on sulcus banks.

The sufficient explanation of potential fields generated by extended cortical sources means that there is no modeling error involved which can lead to ambiguous and erroneous results produced by computational methods. Even if such modeling error is negligible in cases of small number of dipoles, it may be an important issue in complex neural activation with multiple sources since the extent contrast among sources and, sequentially, their different sensitivities in EEG sensors would significantly influence the performance of computational methods. In the subspace source localization method, inaccurate source modeling decreases the source detection sensitivity, which allows real sources to be buried in noises and other influences. Coupled with the sensitivity shift caused by the array ambiguity phenomenon, which means that the linear combination of some true sources produces the same output as single source at other location, the subspace source localization method may falsely detect real sources and erroneously pick up false sources. With the dipole model, two simulated sources are uncovered and a false source is consistently detected (FIG. C-2F).

The present source model is based on the multipole expansion of the scalar potential field. The consideration of higher-order moments, i.e. quadrupole moments, is able to explain the potential fields generated by cortical sources. Source modeling tackled by the multipole expansion of the scalar electric potential and the magnetic vector potential can be used for magnetocardiography (MCG) and MEG with focuses on understanding the measured electrical and magnetic fields and simple biomagnetic source localization, such as a single source, with spherical volume conductor model for the human head. The present subject matter allows localized multiple sources in complex neural activations using a more realistic human head model. The boundary element model is used to account for the realistic geometry of the human head and the major conductive barrier, i.e. the skull. Simulation has indicated that the influence from the volume conductor model in localizing spatially extended sources is significant even for MEG data, which is less affected by the low conductive skull.

The present subject matter includes a source model capable of source localization using electromagnetic recordings from simple tasks (1 or 2 sources) to complex tasks (7 sources in the present example but greater numbers are also contemplated), and can be applied to real data obtained from a visual stimulation. The present subject matter differs from the classic dipole model and the current density source model. The present subject matter retains its parameter space on the order as in the dipole model and, at the same time, stands for the extended cortical sources as in the current density source model. The present subject matter makes the associated computational methods more precise in localizing multiple sources in the human cortex by avoiding the modeling inaccuracy and, more generally, it enables the spatio-temporal imaging of distributed cortical activations during task performance or rest in physiological or pathological conditions.

### Methods—Modeling

The external EEG field produced by a cortical source with arbitrary extent (FIG. C-1) can be expressed in terms of an infinite Taylor series expansion. Before consider the EEG field in the presence of complex conductivity profile, i.e. the human head, start with the infinite and homogeneous medium of conductivity σ.

$$\begin{matrix}{E}^{∞} ( r ) = {\sum }_{n = 0}^{∞} \frac{1}{4 πσ} {\int }_{Ω} J ( {r}^{′} ) ∇ ( {\frac{1}{n !} [ ( {r}^{′} - l ) \cdot {∇}^{′} ]}^{n} {( \frac{1}{\vert r - {r}^{′} \vert} )}_{{r}^{′} = l} ) {d}^{3} {r}^{′} \\ = \frac{1}{4 πσ} ( \frac{r - l}{{\vert r - l \vert}^{3}} {\int }_{Ω} J ( {r}^{′} ) {d}^{3} {r}^{′} + \\ ( \frac{- 3 {( r - l )}^{T} {( r - l )}^{T} + I {\vert r - l \vert}^{2}}{{\vert r - l \vert}^{5}} ) \\ {\int }_{Ω} J ( {r}^{′} ) ( {r}^{′} - l ) {d}^{3} {r}^{′} + … )\end{matrix} \qquad Eq . C \text{-} 1$$

where E^{χ}(r) is the EEG field, measured at the location r, about an arbitrary expansion point l, and J(r′) is the current density distribution at the location r′ around the expansion point l. If the current sources are concentrated in an area that is very small compared to the distance to electrodes, approximate the current sources by the zeroth-order term, a dipole ∫_{Ω}J(r′)d³r′. The convoluted and extended cortical sources (FIG. C-1) are considered as the violation of the above assumption. Model such sources with current multipoles by considering the contribution from, besides dipole, the first-order term in Eq. C-1, a quadrupole ∫_{Ω}J(r′)(r′−l)d³r′.

The EEG field in the presence of the human head can be connected to the EEG field in the infinite homogeneous media by boundary element method (BEM).

(l+B)E=E^{χ} Eq. C-2

where I is the diagonal matrix and B is the function of geometry and conductivity profile of the human head, which are represented by a piecewise homogeneous conductor of three compartments, i.e. the scalp, skull, and brain, within which the skull has conductivity value 20 times lower than those of the scalp and brain. Note E^{∝} here is the EEG field generated by multipole, not by dipole, in the infinite homogeneous medium.

### Computational Method

The subspace source localization method, such as MUSIC algorithm, scans the entire possible source space and calculates the SC of two subspaces. One subspace is spanned by either dipole or multipole at each scanned point, calculated at each EEG sensor by Eq. C-2 and stacked to form the gain matrix A, and another subspace is the so-called noise-only subspace estimated from the EEG correlation matrix, R_{E}=AR_{S}A^{T}+R_{N}, where R_{S} and R_{N} are the source signal and noise correlation matrices, respectively. The signal subspace Vₛ=[ν₁, ν₂, . . . νₚ] are spanned by those p eigenvectors, obtained from the eigen-decomposition of R_{E}, with their corresponding eigen-values higher than the noise level in R_{N}. The rest eigenvectors span the noise-only subspace Vₙ=I−Vₛ. If SC{A(r), Eₙ} is approximate to zero at a scanned point, this point is regarded as a source. Multiple sources can be obtained at multiple extreme values. The metric SC₁(r) used in the present work is modified from the classic SC in MUSIC algorithm

SC₁(r)=SC{A(r),Vₙ}/SC{A(r),└νₚVₙ┘} Eq. C-3

In Eq. C-3, the numerator of SC₁(r) is the classic MUSIC estimator and the denominator is the normalization term, and this formulation is obtained by the usage of L1 norm instead of standard L2 norm for the calculation of SC. Its performance has been demonstrated better in terms of spatial resolvability of sources in one-dimensional radar sensor array problem and is used here with a three-dimensional EEG sensor array. The metric SC₁(r) is a vector since the dipole has 3 independent moments and the quadrapole has 6 independent higher-order moments, which makes a multipole of 9 independent moments. The moments can be estimated as the singular vectors associated with the approximate zero SC values by SVD analysis.

The above description is intended to be illustrative, and not restrictive. For example, the above-described embodiments (or one or more aspects thereof) may be used in combination with each other. Other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

1-42. (canceled)

43. A system comprising:
an interface configured to receive epileptiform data from a brain;
a memory to store a model for the brain; and
a processor coupled to the memory and to the interface, the memory having instructions stored thereon for executing an algorithm to determine a solution using the epileptiform data and the model, the solution including identification of a plurality of sources, an estimate of spatio-temporal distribution for the plurality of sources, and including an estimate of connectivity for at least two sources of the plurality of sources.

44. The system of claim 43 wherein the algorithm is configured to determine connectivity at a particular frequency.

45. The system of claim 43 wherein the algorithm is configured to identify at least one primary source of the plurality of sources.

46. The system of claim 43 wherein the interface is configured to receive data corresponding to at least one of intracranial data, electroencephalogram (EEG) data, and magnetoencephalogram (MEG) data.

47. The system of claim 43 wherein the model includes at least one of a distributed dipole source model and a distributed multipole source model.

48. A method comprising:
receiving data corresponding to spatio-temporal cortical electrical potential distribution, the data including a plurality of interictal spikes;
calculating latencies between interictal spikes; and
determining a cortical neuronal activation sequence using the latencies.

49. The method of claim 48 further including identifying an epileptic seizure onset zone based on the latencies.

50. The method of claim 48 wherein the algorithm is configured to generate a solution using at least one of an amplitude, a first derivative, and a second derivative.

51. The method of claim 48 wherein calculating latencies between interictal spikes includes calculating using a peak amplitude.

52. The method of claim 48 further including generating a map using the cortical neuronal activation sequence.

53. A system comprising:
means for receiving data corresponding to brain activation over at least one of a brain surface and a brain volume;
means for determining a brain activation sequence using the data; and
means for generating an activation map using the activation sequence.

54. The system of claim 53 wherein the means for receiving data includes means for receiving intracranial electrical data, means for receiving noninvasive magnetic data, or means for receiving noninvasive electrical data.

55. The system of claim 53 wherein at least one of the means for determining and the means for generating includes a processor.

56. The system of claim 53 wherein the means for generating includes at least one of a printer and a visual display.

57. The system of claim 53 wherein the means for determining includes a dipole source model or a multipole source model, wherein the multipole source model includes more than two poles.
